(19) United States
(12) Patent Application Publication
(10) Pub. No.: US 2026/0187189 A1
(43) Pub. Date: Jul. 2, 2026

(54) System of Interconnected State Space Models with Jointly Driven State Matrices

(71) Applicant: BrainChip, Inc., Laguna Hills, CA (US)

(72) Inventors: Yan Ru PEI, Irvine, CA (US); Nolan Ardolino, Laguna Hills, CA (US); Olivier Jean-Marie Dominique COENEN, PhD., Encinitas, CA (US); M. Anthony Lewis, La Jolla, CA (US)

(21) Appl. No.: 19/434,845

(22) Filed: Dec. 29, 2025

Related U.S. Application Data
(60) Provisional application No. 63/740,235, filed on Dec. 30, 2024.

(51) Int. Cl. G06F 17/16; G06N 3/048

(52) U.S. Cl. CPC G06F 17/16; G06N 3/048

(57) ABSTRACT

Systems and methods performed by a processor of a computing device for implementing a plurality of state space models (SSM) by a processing system. Embodiments may include receiving a data input at a driving SSM, generating a driving output of the driving SSM based on the data input, parameterizing a driven SSM based on the driving output, in which the driving SSM and the driven SSM are connected by a lateral connection, receiving a second data input at the driven SSM, and generating a driven output of the driven SSM based on parameterization of the driven SSM and the second data input.

### CROSS-REFERENCE TO RELATED APPLICATIONS

This application claims the benefit of priority to U.S. Provisional Application No. 63/740,235, titled “System of Interconnected State Space Models with Jointly Driven State Matrices,” filed on Dec. 30, 2024, the entire contents of which are hereby incorporated by reference for all purposes.

### FIELD OF INVENTION

The present disclosure generally relates to the fields of artificial intelligence and machine learning. In particular, the present disclosure relates to neural networks and deep learning models, including state-space models (SSMs). More specifically, the disclosure relates to temporal modeling and/or context-based modeling using SSMs and techniques for improving the adaptability and computational efficiency of such models in dynamic environments. Some aspects of the present disclosure may relate to real-time audio processing techniques, including denoising, super-resolution, and dequantization of audio signals. Some aspects may relate to computing devices configured to perform audio enhancement, including edge devices and resource-constrained systems. Some aspects of the present disclosure may relate to the efficient operation of large language models (LLMs).

### BACKGROUND

State space models (SSMs) may be a class of general representations for linear time-invariant (LTI) systems, frequently utilized in signal processing and sequence modeling in a wide variety of applications, including automatic sound processing, image processing (e.g., in self-driving cars), statistical modeling (e.g., in large language models), and the like. In a conventional discrete-time SSM, the system's behavior is typically governed by a set of matrices—specifically A (the state transition matrix), B (the input matrix), and C (the output projection matrix). These matrices may define how an internal state xₜ evolves over time based on current inputs uₜ and how that state may be mapped to an output yₜ. In traditional neural network architectures utilizing SSM layers, these matrices (or “weights”) are typically learned during a training phase and remain static during inference. While these fixed weights allow the model to capture general temporal patterns observed in the training data, they lack the ability to adapt their internal dynamics to the specific nuances of the incoming data stream, for example, when processing in real time.

Modern deep learning systems may employ sequential or “feedforward” chaining, in which the output of one layer is passed directly as the input to the subsequent layer. In the context of deep SSMs, this means a first SSM layer generates an output sequence that may be passed through a non-linear activation function before serving as the raw input for a second SSM layer. In this conventional paradigm, while the data flows through the layers, the underlying mathematical rules governing each layer (defined by the matrices (A, B, and C)) do not change in response to the context of the data being processed.

Additionally, efficiently deploying SSMs on hardware may present significant challenges. Standard recurrent implementations may often be computationally expensive and difficult to parallelize. While some conventional systems attempt to use Fast Fourier Transform (FFT) convolutions for training, these methods are often restricted to linear systems with fixed parameters and cannot easily accommodate models with time-varying parameters. Further, existing hardware implementations often suffer from high memory bandwidth requirements, frequently transferring data between fast on-chip memory (SRAM) and slower off-chip memory (DRAM), thereby limiting throughput and increasing power consumption.

Thus, there is a growing need for complex tasks, for example, tasks like language modeling, real-time audio/image processing, and/or synthesis, that the systems implementing processing exhibit “dynamicity” during inference. Conventional static-weight systems may often fail to adequately adjust to shifting contexts within a single sequence of data. Consequently, there is a technical need for a new class of interconnected models in which the internal dynamics of one system can be modulated to adapt dynamically. Further, to make such dynamically adaptive architectures practical, there is a corresponding need for hardware-efficient processing methods that can maintain high performance, utilize parallel processing resources, and minimize off-chip data transfers.

### SUMMARY

The various aspects include methods for implementing an interconnected SSM configured for driving an SSM on a computing device.

Further aspects may include a computing device having at least one processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause at least one processor or processing system to perform various operations corresponding to the method operations discussed above.

Some embodiments may include a computing device having a memory that stores instructions and a plurality of state space models. The computing device may include a processor configured to execute the instructions to receive an input data sequence and process the input data sequence using a first state space model to generate a driving output. The processor may be configured to modify at least one internal state matrix of a second state space model based on the driving output generated by the first state space model. The processor may generate a driven output based on the second state space model and the modified internal state matrix of the second state space model. The driven output may be associated with an improved prediction metric relative to a prediction metric for the second state space model without modifying the at least one internal state matrix of the second state space model.

In some embodiments, the processor may apply an activation function to the driving output signal to generate a modified driving output, and the modified driving output may be used to modify the internal state matrix of the second state space model. The activation function may be a non-linear activation function bounded by values −1 and +1, and the bound may improve a likelihood of stability of the second state space model. In some embodiments, the activation function may be a tanh activation function. The internal state matrix of the second state space model that is modified by the processor may be a diagonal state transition matrix (Á) configured to govern the dynamics of the second state space model. In some embodiments, the internal state matrix that is modified may be at least one of an input matrix (\acute{B}) of the second state space model or an output matrix (C) of the second state space model. In some embodiments, the internal state matrix may represent an activation function used by the second state space model. In some embodiments, the processor may generate a low rank projection of the input matrix or the output matrix prior to modification based on the driving output, and the low rank projection may reduce a dimensionality of the input matrix or the output matrix.

In some embodiments, the first state space model may be a driving state space model layer and the second state space model may be a driven state space model layer, and the driving state space model layer and the driven state space model layer may be part of a feedforward neural network architecture. The processor may generate a second driving output using a third state space model that is a second driving state space model layer and may modify the internal state matrix of the driven state space model layer based on a combination of the first driving output and the second driving output. In some embodiments, the processor may identify a third state space model that is a second driven state space model layer different than the first driven state space model layer, modify at least one internal state matrix of the second driven state space model layer based on the driving output, and generate the driven output based on the first driven state space model layer and the second driven state space model layer. The processor may modify the internal state matrix by parameterizing the internal state matrix, and parameterizing may include adjusting one or more values of the internal state matrix based on the driving output.

In some embodiments, the processor may utilize an associative scan algorithm or a cumulative sum operation to parallelize the processing of the first state space model and the second state space model. In some embodiments, the first state space model and the second state space model may be connected via a lateral connection used to convey the driving output from the first state space model to the second state space model. In some embodiments, the first state space model and the second state space model may be connected via a feedforward connection used to convey a feedforward output signal from the first state space model to the second state space model. The driving output may be used to influence or configure the operation of the second state space model. The improved prediction metric associated with the input data sequence may have a greater likelihood to account for a dependency related to a history or context associated with the input data sequence.

Some embodiments may include a method performed by at least one processor in a processing system of an edge device. The method may include receiving an input data sequence and processing the input data sequence using a first state space model to generate a driving output. The method may include modifying at least one internal state matrix of a second state space model based on the driving output generated by the first state space model. The method may include generating a driven output based on the second state space model and the modified internal state matrix of the second state space model. The driven output may be associated with an improved prediction metric relative to a prediction metric for the second state space model without modifying the at least one internal state matrix of the second state space model.

Some embodiments may include a non-transitory processor-readable storage medium having stored thereon processor-executable instructions configured to cause a processor to perform operations. The operations may include receiving an input data sequence and processing the input data sequence using a first state space model to generate a driving output. The operations may include modifying at least one internal state matrix or an activation function associated with a second state space model based on the driving output generated by the first state space model. The operations may include generating a driven output based on the second state space model and the modified internal state matrix of the second state space model. The driven output may be associated with an improved prediction metric compared to a prediction based on not modifying the at least one internal state matrix of the second state space model.

### BRIEF DESCRIPTION OF FIGURES

The accompanying drawings, which are incorporated herein and constitute part of this specification, illustrate exemplary aspects of the invention and, together with the general description given above and the detailed description given below, serve to explain the features of the invention.

FIG. 1 is a component diagram of an on-chip system (SOC) suitable for implementing some embodiments.

FIG. 2 is a component block diagram illustrating an example of a driving SSM module in accordance with some embodiments.

FIGS. 3A-3F are component block diagrams illustrating examples of interconnected SSMs in accordance with some embodiments.

FIGS. 4A-4E are component block diagrams illustrating examples of interconnected SSMs in which a driving SSM drives components of a driven SSM in accordance with some embodiments.

FIG. 5 is a component block diagram illustrating an example of an interconnected SSM network in accordance with some embodiments.

FIG. 6 is a process flow diagram illustrating an example flow/method for implementing interconnected SSMs configured for driving a driven SSM in accordance with some embodiments.

FIG. 7 is a pseudocode diagram illustrating an example of event-based processing on sparse inputs and fusion of state updates in accordance with some embodiments.

FIG. 8 is a component block diagram illustrating an example of event-based processing on sparse inputs and fusion of state updates in accordance with some embodiments.

FIG. 9 is a process flow diagram illustrating an example flow/method for implementing event-based processing on sparse inputs and fusion of state updates in accordance with some embodiments.

FIGS. 10A and 10B are component block diagrams illustrating examples of fixed-point quantization of internal states in accordance with some embodiments.

FIG. 11 is a process flow diagram illustrating an example flow/method for implementing fixed-point quantization of internal states in accordance with some embodiments.

FIG. 12 is a component block diagram illustrating an example edge computing device in the form of a headset that is suitable for implementing some embodiments.

FIG. 13 is a component block diagram illustrating an example edge computing device in the form of a laptop that is suitable for implementing some embodiments.

FIG. 14 is a component diagram of a server suitable for implementing some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

The word “exemplary” may be used herein to mean “serving as an example, instance, or illustration”. Any implementation described herein as “exemplary” is not necessarily to be construed as preferred or advantageous over other implementations.

In overview, the embodiments include methods, state machines, processing systems, and computing devices configured to process input data using interconnected state-space model (SSM) layers. These systems may dynamically adapt internal states and matrix parameters to improve computational efficiency and context-aware processing. For example, a processing system may be operatively coupled to a first SSM layer that receives input data, updates an internal state using recurrent dynamics, input projections, and output projections, and generates an output. This output may be used to dynamically modify at least one matrix of a second SSM layer, which may process the input data with the dynamically modified matrix to produce a second output.

Some embodiments may include a computing device that pairs a driving SSM layer with a driven SSM layer. The driving SSM layer may process an input data sequence and generate a driving output that reflects the context within the input data sequence. The driven SSM layer may use the driving output to parameterize at least one state transition matrix during inference for the input data sequence and generate a driven output that adapts to shifts in the input data sequence without a separate retraining step. This may provide event-based processing and on-chip state update operations that decrease computation and DRAM read traffic for the input data sequence.

Some embodiments may include a computing device that includes a memory that stores instructions for a plurality of interconnected SSM layers and a processing system configured to receive an input data sequence and execute a driving SSM layer that updates a driving state vector via a driving state transition matrix, a driving input matrix, and a driving output matrix. The driving SSM layer may generate a driving output. The processing system may parameterize at least one matrix of a driven SSM layer as a function of the driving output. During inference, the processing system may execute the driven SSM layer to update the driven state vector using the parameterized matrix and generate a driven output.

In some embodiments, the processing system may organize the plurality of interconnected SSM layers into a feature path and a control path. The feature path may process the input data sequence to generate a feature output sequence. The control path may process the input data sequence to generate driving outputs for matrix-parameterizing the SSM layers of the feature path. A lateral connection may couple a control-path SSM layer with a feature-path SSM layer. The processing system may perform event-based processing for an input vector of an SSM layer. Event-based processing may apply an event criterion that selects nonzero input elements for multiply-accumulate operations. The processing system may perform quantization of an internal state vector or a state-space matrix. Quantization may replace a scaling multiplication with a shift operation under a dyadic representation.

In some embodiments, the processing system may execute a feedforward connection between successive SSM layers for feature propagation and a lateral connection for matrix parameterization. The processing system may apply an associative scan algorithm or a cumulative sum operation for parallel state updates. The processing system may reduce off-chip memory traffic by storing intermediate state-update values on-chip across an input projection and a state update. The processing system may apply the interconnected SSM layers to sequence processing tasks, such as language modeling, audio processing, and medical signal processing.

A data-controlled SSM layer may include at least one state-space matrix with element values that vary with a data signal. The data signal may include the input data sequence, a driving output from another SSM layer, or a combination output from a combination layer. A conventional SSM layer may hold state-space matrix element values constant during inference. A data-controlled SSM layer may update at least one matrix element value for a time index of the input data sequence. The matrix update may alter a state update equation for that time index. The matrix update may improve the representation of nonstationary temporal dependencies within the input data sequence.

In some embodiments, the driven SSM layer may update a driven state vector xₜ via a state transition matrix A, an input matrix B, and an output matrix C. The processing system may treat at least one of A, B, or C as a data-controlled matrix. The processing system may derive a matrix control vector from the driving output, map the matrix control vector to one or more element values of the data-controlled matrix, and store the one or more element values in the data-controlled matrix prior to execution of a state update at a time index.

In some embodiments, the processing system may repeat matrix parameterization for successive time indices of the input data sequence. The processing system may select a parameterization granularity that assigns either one matrix control vector per time index or one per data segment. The processing system may apply a lateral activation function to the driving output before deriving the matrix control vector. The lateral activation function may constrain the range of values in the matrix control vector. For parameterization of the state transition matrix A, the constrained value range may bound the magnitude of a state update factor of A, which may reduce divergence of the driven state vector. The processing system may apply the driven output to text generation, audio enhancement, or audio synthesis.

The term “processing system” may be used herein to refer to one or more processors, including multi-core processors, that are organized and configured to perform various computing functions. Various embodiment methods may be implemented in one or more of multiple processors within a processing system of a computing device, as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include at least one processor of a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, a SIP may include a single substrate on which multiple IC chips or semiconductor dies are stacked vertically. Similarly, the SIP may include one or more multi-chip modules (MCMs) that package multiple ICs or semiconductor dies onto a unifying substrate. An SIP may also include multiple independent SOCs coupled via high-speed communication circuitry and packaged in close proximity, such as on a single motherboard, within a single UE, or within a single CPU device. The proximity of the SoCs facilitates high-speed communications and the sharing of memory and resources.

The terms “machine learning algorithm” and “artificial intelligence model” and the like may be used interchangeably herein to refer to a variety of computational models or information structures that may be used by a computing device to perform tasks, computations, or evaluations. Examples of machine learning algorithms include neural network models, inference models, classifiers, random forest models, spiking neural network (SNN) models, convolutional neural network (CNN) models, recurrent neural network (RNN) models, state-space models (SSMs), deep neural network (DNN) models, generative adversarial networks (GANs), ensemble networks, and genetic algorithm models. In some embodiments, a machine learning algorithm may include an architectural definition (e.g., neural network architecture) and corresponding weights (e.g., neural network weights).

The term “neural network” may be used herein to refer to an interconnected group of processing nodes (or neuron models) that collectively operate as a software application or process that controls a function of a computing device and generates an overall inference result as output. Individual nodes in a neural network may attempt to emulate biological neurons by receiving input data, performing simple operations on it to generate output data, and passing the output data (also called “activation”) to the next node in the network. Each node may be associated with a weight that defines or governs the relationship between the input and output data. A neural network may learn to perform new tasks over time by adjusting these weight values. In some cases, the overall structure of the neural network and the operations of its processing nodes do not change as it learns a task. Rather, learning is accomplished during a “training” process in which the values of the weights in each layer are determined. For example, the training process may include presenting the neural network with a task for which the expected/desired output is known, comparing the neural network's activations to the expected/desired output, and determining the values of the weights in each layer based on the comparison results. After the training process is complete, the neural network may begin “inference” to process a new task with the determined weights.

The term “inference” may be used herein to refer to a process that is performed at runtime or during the execution of the software application program corresponding to the machine learning algorithm. Inference may include traversing the processing nodes in a network (e.g., neural network, etc.) along a forward path (which may include some backward traversals) to produce one or more values as an overall activation or overall “inference result.”

The term “activation function” may be used herein to refer to a mathematical function applied to the output of a processing node in a neural network. The activation function may include feedforward activation functions applied between layers and lateral activation functions applied between interconnected SSMs.

The term “feedforward activation function” may be used herein to refer to an activation function applied to the output of a neural network layer before passing the output to the next neural network layer in sequence.

The term “lateral activation function” may be used herein to refer to an activation function applied to the output of a driving SSM before its output parameterizes matrices of a driven SSM. This activation function maintains stability or imposes constraints.

The term “deep neural network” may be used herein to refer to a neural network that implements a layered architecture in which the output/activation of a first layer of nodes becomes an input to a second layer of nodes, the output/activation of a second layer of nodes becomes an input to a third layer of nodes, and so on. As such, computations in a deep neural network may be distributed across a population of processing nodes that form a computational chain. Deep neural networks may also include activation functions and sub-functions between the layers. The first layer of nodes in a multilayer or deep neural network is often referred to as the input layer. The final layer of nodes is often called the output layer. The layers between the input and final layers may be referred to as intermediate layers.

The term “recurrent neural network” (RNN) may be used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “state-space model” (SSM) may be used herein to refer to a type of computational model particularly well-suited for handling sequence data by maintaining a compact hidden state that evolves based on the input data. SSMs process input data serially, updating the hidden state at each step, where the hidden state captures all prior information without increasing in size as more data is processed. SSMs may capture long-range temporal relationships among variables by evolving dependencies among input, state, and output variables using stable linear recurrent units. SSMs may be distinct from traditional recurrent neural networks (RNNs) because, for example, they offer more efficient memory usage. In some embodiments, SSMs may be integrated with machine learning algorithms for more efficient processing of large datasets while reducing resource usage requirements. SSMs may be particularly beneficial in systems that benefit from real-time sequence processing, including language modeling systems, audio generation systems, and other advanced AI-driven applications.

The term “data-driven” may be used herein to refer to the operation of a machine learning model that may be influenced or guided by data. The data-driven model is exposed to, rather than being dictated by, pre-defined rules or fixed structures. A data-driven model may rely on the patterns, relationships, and structures learned from the input data to make predictions, decisions, or generate outputs, often without requiring explicit programming for specific tasks. The data-driven model may extract features and patterns directly from the data through training processes, such as supervised learning (using labeled data) or unsupervised learning (finding patterns in unlabeled data). Data-driven models may adapt to the data, allowing the models to generalize to new or unseen data based on what they have learned, rather than relying on pre-coded rules.

The term “prediction metric” may be used herein to refer to a measure of the quality or accuracy of an output or prediction generated by a model in response to input data. A prediction metric may be considered improved when the model generates outputs that more accurately reflect relationships, patterns, or dependencies present in the input data. In the context of SSMs, an improved prediction metric may indicate that the model has a greater likelihood to account for dependencies related to the history or context associated with an input data sequence. For example, in language modeling, an improved prediction metric may reflect the model's ability to generate text that is coherent with preceding words or sentences. In audio processing, an improved prediction metric may reflect the model's ability to suppress noise or enhance signals based on temporal characteristics of the audio stream. The improvement in the prediction metric may result from dynamic adaptation of model parameters based on input data, allowing the model to tailor its processing to the specific context of the data being received.

The term “driving output” may be used herein to refer to an output generated by a first SSM, for example, a driving SSM, that is used to influence or configure a second SSM, for example, a driven SSM. The driving output may include values derived from processing input data through the first (driving) SSM, and these values may be used to set or adjust parameters of the second (driven) SSM, such as matrix weights or activation function characteristics. In some embodiments, the driving output may be transformed by an activation function before being provided to the driven SSM.

The various embodiments include methods, state machines, processing systems, and computing devices configured to implement a plurality of SSMs by a processing system. Embodiments may include receiving a data input at a driving SSM, generating a driving output of the driving SSM based on the data input, and parameterizing a driven SSM based on the driving output. The driving SSM and the driven SSM may be connected through a lateral connection in which the driving SSM's output directly influences the state-space matrices of the driven SSM. Embodiments may further include receiving a second data input at the driven SSM and generating a driven output of the driven SSM based on parameterization of the driven SSM and the second data input.

SSMs may be representations of linear time-invariant (LTI) systems and may be uniquely specified by four matrices: Aϵ [symbol] ^{h×h}, Bϵ [symbol] ^{h×p}, Cϵ [symbol] ^{m×h}, and Dϵ [symbol] ^{m×p}. Each matrix may include a set of the real values of internal states h, inputs n, and outputs m. A first-order ordinary differential equation describing the LTI system may be given as:

$${x}^{′} = Ax + B u , y = C x + Du$$

where u(t)ϵ [symbol] ⁿ may be an input signal, x(t)ϵ [symbol] ^{h} may be an internal state, and y(t)ϵ [symbol] ^{m} may be an output for a time t. In some embodiments, n>1, m>1, which may yield a multiple-input, multiple-output (MIMO) SSM. In some embodiments, the D matrix may be omitted for simplicity, effectively assuming Du=0 for computational efficiency or modeling simplicity.

In the embodiments and examples described herein, A may be a diagonal real matrix and Du may be omitted for the sake of simplicity and clarity. Using a zero-order hold (ZOH) discretization approach, the discrete-time state-space matrices À and \grave{B} may be computed as follows:

$${A}^{‵} = exp ( Δ A ) ,$$

$${B}^{‵} = {( Δ A )}^{- 1} \cdot ( exp ( Δ A ) - 1 ) \cdot Δ B$$

where Δ represents the sampling interval and exp denotes the matrix exponential.

The discrete SSM may then be given by:

$${x}_{t + 1} = {A}^{‵} {x}_{t} + {B}^{‵} {u}_{t} , {y}_{t} = C {x}_{t}$$

In the context of RNNs, this corresponds to a linear RNN layer, which may allow for efficient online inference and generation, such as for real-time speech enhancement and efficient parallelization during training.

One may check that the discrete-time impulse response is given as:

$${K}_{t} = C {{A}^{t}}^{‵} {B}^{‵}$$

in the sense that the output yₜ may be alternatively computed as the convolution y=u*K, where Kϵ [symbol] ^{m×n×tf} represents the convolution kernel, and t_{f} is the terminal time. While t_{f} may theoretically be infinite, it is often truncated to the length of the input sequence for many practical applications.

Feeding the output (yₜ⁽ⁿ⁾) of an SSM through a (nonlinear) activation function f⁽ⁿ⁾ may allow for its use as input features to another SSM. Said another way, the SSM may operate as a neural network layer that performs linear mapping of sequences. Two such layers (e.g., layer n and layer n+1) may be chained together in a feedforward manner with activation functions applied in between layers. This may be expressed as:

$${u}_{t}^{( n + 1 )} = {f}^{( n )} ( {y}_{t}^{( n )} )$$

This feedforward connection of SSMs allows the training of deep SSM networks using standard optimization methods, such as backpropagation with the Adam optimizer. During training, the A, B, and C matrices of each layer may be updated to adapt to the input data and the specific task. Since the SSM layers themselves are linear (despite the presence of nonlinear activation functions between them), the infinite impulse response (IIR) kernels of the SSM layers may be convolved with the input features at each layer. These convolutions, which may be computationally long, may be performed efficiently using standard algorithms such as fast Fourier transforms (FFT). Similarly, backpropagation computations may also use FFT convolutions for improved efficiency. In addition, because the kernel is induced by an underlying linear time-invariant (LTI) system, the recurrent update operation may be associative and thus allow the use of parallel scan algorithms for hierarchical and efficient processing.

Regardless of whether the state space matrices Ā, B̅, or C are, they may not exhibit explicit dependence on input data and may not be considered data driven. To introduce additional dynamics to the SSM, data dependencies may be incorporated into the matrices as A(uₜ), B(uₜ), and C(uₜ), these matrices become explicit functions of the input u, which may vary over time t. In practice, these functional mappings from the input data to the matrices may be parameterized by standard neural network layers, such as simple linear layers.

However, introducing data dependencies may eliminate the fixed nature of the IIR kernel typically associated with the SSM, as the state-space matrices Ā, B̅, or C are no longer fixed. This means that the method of FFT convolution no longer works (as a convolution cannot be done at all), and other parallelization strategies are needed. Since the underlying system is linear (generally time-varying), linear time-varying (LTV), or linear LTI (linear time invariant), the recurrent update operation may be associative so the parallel scan algorithm may be used.

The associative scan algorithm may perform hierarchical pairwise updates of recurrent states and inputs. Given two pairs, each consisting of a projected input and a recurrent matrix, denoted as (B₁u₁, A₁) and (B₂u₂, A₂), a single step of the parallel scan algorithm may yield the resulting pair (A₂B₁u₁+B₂u₂, A₂A₁). This operation may use the associative properties of matrix addition and multiplication to efficiently combine the inputs and recurrent matrices. The process may be applied recursively until the entire sequence is processed or “scanned,” akin to performing a hierarchical pairwise summation.

Various embodiments include parameterizing the mappings Ā(uₜ), B̅(uₜ), and C(uₜ) of one or more driven SSMs using outputs from one or more driving SSMs. Feature outputs of a driving SSM may serve as inputs to parameterize a driven SSM directly or after undergoing transformations such as linear projections or nonlinear activations. These embodiments may allow for dynamic, data-dependent adaptations of the driven SSM that provide enhanced flexibility and contextual processing.

Some embodiments may include methods, state machines, processing systems, and computing devices configured to process input data using interconnected SSM layers. For example, a processing system may be operatively coupled to a first SSM layer that is configured to receive input data and update an internal state using three matrices: a first matrix representing recurrent dynamics, a second matrix representing input projections, and a third matrix representing output projections. The first SSM layer may generate an output based on the updated internal state, and the processing system may use this output to dynamically modify at least one matrix of a second SSM layer. The second SSM layer may process the input data using the dynamically modified matrix to update its internal state and generate a second output.

In some embodiments, the second SSM layer may include at least one dynamically modified matrix selected from a matrix representing recurrent dynamics, a matrix representing input projections, or a matrix representing output projections. In some embodiments, the processing system may apply a bounded nonlinear activation function to the output of the first SSM layer before modifying the matrix of the second SSM layer. In some embodiments, the dynamic modification of the matrix may occur during inference and/or depending on the characteristics of the input data.

In some embodiments, the processing system may organize the interconnected SSM layers into a main path and a secondary path that each includes a plurality of nodes. Each node in the secondary path may be dynamically linked to a corresponding node in the main path, and the nodes in the secondary path may drive matrices in their corresponding main path nodes via bijective connections. In some embodiments, the processing system may implement an event-based processing mechanism to skip computations for input data elements identified as zero (thereby enhancing processing efficiency).

In some embodiments, the processing system may perform quantization operations in which at least one scaling operation is replaced with a bit-shifting operation to improve computational efficiency. In some embodiments, the processing system may combine outputs from multiple SSM layers using a nonlinear transformation to generate a final output. In some embodiments, the interconnected SSM layers may be configured in a feedforward topology with no directed cycles to support training via backpropagation. In some embodiments, the processing system may be configured to train the interconnected SSM layers using a cumulative summation algorithm optimized for parallel hardware implementations. In some embodiments, the processing system may apply a logarithmic cumulative sum of exponentials to enhance numerical stability during training. In some embodiments, the processing system may be configured to support sequence modeling applications, such as language processing, audio processing, and medical signal processing. In some embodiments, the processing system may be configured to use the adaptability and computational efficiency of the interconnected SSM layers to manage complex data dependencies.

Some embodiments may provide a computational framework for dynamically adapting SSMs (SSMs) in a computational environment to address the complexities of context-aware processing. Some embodiments may use dynamic weight adjustments to achieve more efficient resource utilization and enhanced adaptability during inference, particularly in applications that benefit from real-time or sequential data processing. Some embodiments may use a combination of event-based mechanisms, quantization techniques, and enhanced network topologies to reduce computational overhead while maintaining robust performance across a wide range of applications.

Some embodiments may include improved solutions for integrating interconnected SSM layers that allow for dynamic modification of state-space matrices based on input characteristics. This dynamic behavior may allow the system to tailor its processing to the specific context of the input data to improve its computational accuracy and efficiency. For example, some embodiments may use feedforward and lateral connections to maintain a flexible network topology that allows for context-sensitive processing without requiring extensive retraining or redundant computational resources.

Some embodiments may enhance numerical stability during training and inference through enhanced cumulative summation techniques and bounded nonlinear activation functions. These features may support the reliable and efficient operation of the device in environments with constrained computational resources, such as edge devices or parallel hardware implementations. Some embodiments may provide a robust computational foundation for addressing complex data dependencies in practical scenarios to support applications such as language processing, audio recognition, and medical signal analysis.

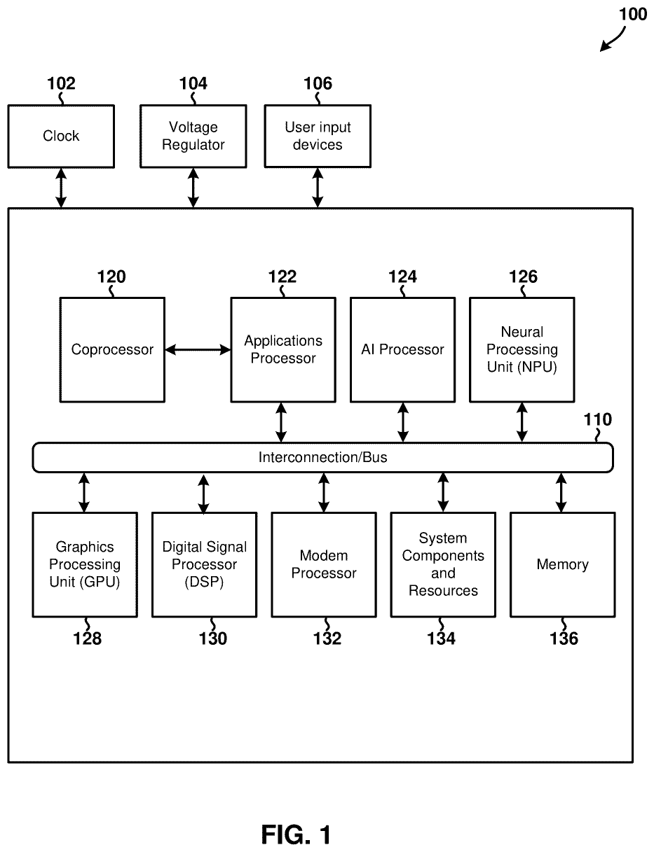

Various embodiments may be implemented in single-processor or multiprocessor computer systems, including a system-on-chip (SoC) or system-in-package (SiP). FIG. 1 illustrates an example computing system or SoC 100 architecture that may be included in computing devices implementing the various embodiments.

In the example illustrated in FIG. 1, the SoC 100 includes a clock 102, voltage regulator 104, and user input devices 106 (e.g., touch-sensitive displays, microphones, cameras). The SoC 100 integrates various processors, including a coprocessor 120 (e.g., vector coprocessor), applications processor 122, AI processor 124, and neural processing unit (NPU) 126. Additional components include the graphics processing unit (GPU) 128, digital signal processor (DSP) 130, modem processor 132, memory 136, and system components and resources 134. The processors and components may be interconnected via an interconnection/bus 110, which may utilize advanced interconnect technologies such as high-performance networks-on-chip (NoCs), reconfigurable logic arrays, or bus architectures like CoreConnect or AMBA.

In some embodiments, any of the processors 120-132 in the SoC 100 may function as the central processing unit (CPU), microprocessor unit (MPU), or arithmetic logic unit (ALU). The SoC 100 may execute software programs, performing arithmetic, logical, control, and input/output (I/O) operations as specified by program instructions (e.g., processor-executable instructions, etc.). One or more of the coprocessors 120 may be configured to assist the CPU in these operations. For example, coprocessors 120 may assist the CPU by offloading specialized tasks, such as AI inference or data pre-processing.

Each processor 120-132 may include one or more cores, and each processor/core may perform operations independent of the other processors/cores. For example, the SOC 100 may include a processor that executes a first type of operating system (e.g., FreeBSD, LINUX, etc.) and a processor that executes a second type of operating system (e.g., OS X, etc.).

In some embodiments, any or all of the processors 120-132 may be part of a processing cluster, such as a heterogeneous processor cluster architecture. In some embodiments, any or all of the processors 120-132 may operate as part of CPU clusters, with interconnected nodes (e.g., cores, processors, SoCs) working in coordination to perform computational tasks. Each node may have its own operating system, CPU, memory, and storage. A computational task may be divided among these nodes, allowing for parallel processing. The results from each node's computation may be combined to produce a final result (often faster compared to a single processor). CPU clusters also offer greater reliability and resilience to failure due to their distributed nature.

The SoC 100 includes various system components and resources for managing sensor data, wireless transmissions, analog-to-digital conversions, and other specialized tasks, such as performing AI inference or precomputing hidden states for frequently used input text. These components may include power amplifiers, voltage regulators, oscillators, phase-locked loops, data controllers, memory controllers, and peripheral bridges. The system components also facilitate communication with peripheral devices such as cameras, microphones, external displays, and wireless communication modules.

The SoC 100 may further include an input/output (I/O) module (not shown) for interfacing with external resources such as the clock 102, voltage regulator 104, user input devices 106, and wireless transceivers (e.g., Bluetooth, cellular transceivers). These external resources may be shared among multiple processors or cores within the SoC 100.

In addition to the SoC 100, various embodiments may be implemented in other computing systems, including those with single or multicore processors, multiple processors, or hybrid configurations that integrate different processing technologies.

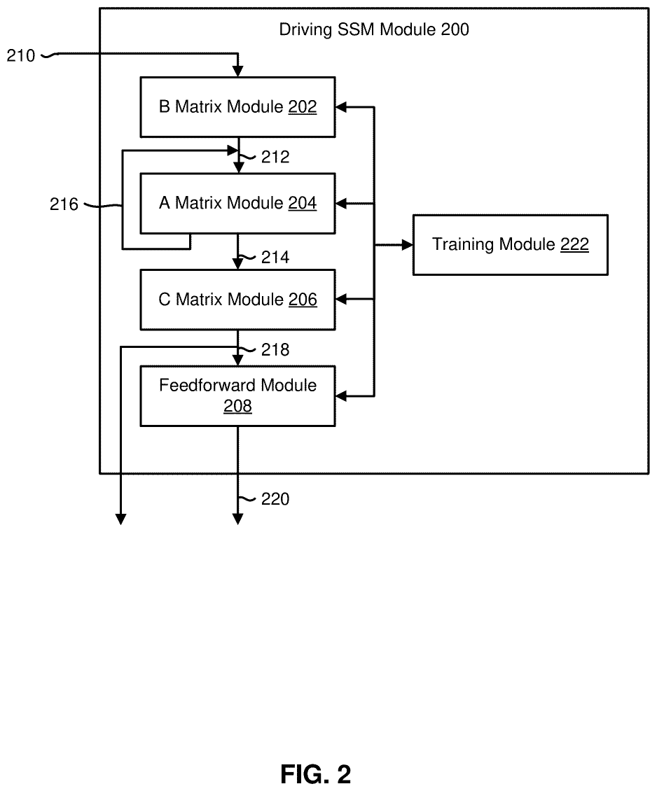

FIG. 2 illustrates a driving SSM module 200 of an interconnected SSM systems in accordance with some embodiments. The driving SSM module 200 may be configured as hardware integral to or separate from the SoC 100 or software stored on memory 136 and executed by a processing system, including one or more processors 120-132. The driving SSM module 200 may include various modules, such as a B matrix module 202, an A matrix module 204, a C matrix module 206, a feedforward module 208, and a training module 222 configured as the hardware or software for executing functions of the driving SSM module 200. The modules 200-208, 222 may include more or fewer modules, for example, by splitting, combining, adding, or removing functions.

The driving SSM module 200 may parameterize the mappings Ā(uₜ), B̅(uₜ), and C(uₜ) of a driven SSM layer (not shown) using outputs of the B matrix, A matrix, C matrix, and feedforward modules (e.g., modules 202-208). For brevity and clarity, embodiments and examples are described herein for parameterization of Ā(uₜ) of the driven SSM layer, but the scope of the descriptions and claims are not limited to parameterization of Ā(uₜ). In some embodiments, parameterization of B̅(uₜ), and/or C̅(uₜ) of one or more driven SSM layer(s), with or without the parameterization of Ā(uₜ). of the same and/or different driven SSM layer(s), may be executed by similar means as described for Ā(uₜ). Further, embodiments may include parameterizing any combination of Ā(uₜ), B̅(uₜ), and C(uₜ) of any combination of driven SSM layer(s). In some embodiments, parameterization of Ā(uₜ) may be more implemented more practically than parameterizing B̅(uₜ), or C(uₜ) due to a low dimensionality of Ā(uₜ). as Ā(uₜ) may be a diagonal matrix. In some embodiments, the parameterizing of B̅(uₜ), or C(uₜ) of a driven SSM layer may include one or more steps including a low rank projection to accommodate a higher dimensionality of the B̅(uₜ), or C(uₜ) matrices.

The feedforward module 208 may be configured to apply a feedforward activation function f to the output of the C matrix module 206. The feedforward activation function f may introduce nonlinearity before the outputs are sent to the next processing node.

The lateral activation function g may be applied to various outputs of the driving SSM module 200. For example, as illustrated in FIG. 2, the driving SSM module 200 may generate an output 218 of the C matrix module 206. For other examples, the driving SSM module 200 may generate an output 212 of the B matrix module 202 or an output 214 of the A matrix module to which the lateral activation function g may be applied. The lateral activation function g may modify the output before parameterizing matrices in the driven SSM to constrain the outputs to specific ranges. For example, the lateral activation function g may use bounded functions such as tanh to limit the outputs and prevent divergence of internal states in interconnected SSM systems.

The training module 222 may optimize parameters of the driving SSM module 200, including weights and configurations of the feedforward activation function f and lateral activation function g. During training, gain coefficients may be gradually adjusted to balance stability and adaptability of the interconnected SSM system.

The driving SSM module 200 may output y′ based on a set of (fixed) Ā′, B̅′, and C′ matrices:

$${x}_{t + 1}^{′} = {{A}^{′}}^{‵} {x}_{t}^{′} + {{B}^{′}}^{‵} {u}_{t} , {y}_{t}^{′} = {C}^{′} {x}_{t}^{′}$$

Where uₜ input 210 is the same input to the driven SSM layer, though in general it may also be a subset or a transformation of the uₜ input 210. The B matrix module 202 may generate a \grave{B}′uₜ output 212 based on the uₜ input 210. The A matrix module 204 may generate an x′ₜ output 214 and an À′x′ₜ output 214 and \grave{B}′u, output 212 from an earlier time (e.g., Ā′x′ₜ₋₁, \grave{B}′uₜ₋₁). Similarly, the A matrix module 204 may generate an x′ₜ₊₁ based on the Ā′x′ₜ output 214 and the \grave{B}′uₜ output 212. The C matrix module 206 may generate a y′ₜ output 218 based on the x′ₜ output 214 and send the y′ₜ output 218 to the driven SSM. The driven SSM layer may use the y′ₜ output 218 as an Ā matrix, Āₜ=y′ₜ. In some embodiments, the output of the subsystem y′ₜ may be fed through a lateral activation layer (not shown) executing an activation function g to yield the Ā matrix of the driven SSM layer, Āₜ=s(y′ₜ). In some embodiments, the B matrix module 202 may send the e \acute{B}′uₜ output 212 or the A matrix module 204 may send the x′ₜ output 214 to the driven SSM. In some embodiments, the output of the subsystem \acute{B}′uₜ or x′ₜ may be fed through the lateral activation layer executing the activation function g. The y′ₜ output 218 may also be input to the feedforward module 208, which apply the feedforward activation function f and generate a feedforward output 220.

In some embodiments, the activation function g may follow certain restrictions to guarantee stability of interconnected SSM systems. For example, when driving the A matrix, the activation function may be bound from −1 to 1 to ensure that internal states do not diverge. For example, a natural choice would be the hyperbolic tangent (tanh) activation function whose output is in (−1, +1).

In some embodiments, the state space matrices Ā, B̅, and C may have both an input independent component and an input dependent component, where the input dependent component may provide a modulation over the input independent component as the input 210 changes. The input independent component may provide a backbone for the parameters, such that a smaller modulation with the inputs 210 over the input independent component may be easier to construct.

The input modulation may be implemented through different operations by the A matrix module 204, including an additive modulation and a multiplicative modulation. For example, the state space matrix may be written for an additive modulation as:

$${A}^{‵} ( {u}_{t} ) = {A}_{*} + G {A}^{‵} ( {u}_{t} )$$

or a multiplicative modulation as:

$${A}^{‵} ( {u}_{t} ) = {A}_{*} {A}^{‵} ( {u}_{t} )$$

where A_{*} is input independent, À is input dependent and G is a gain coefficient to potentially weight the input-dependent contribution relative to the input-independent one.

The base matrix A_{*} may be selected to be a matrix derived from certain stable recurrence relationships, such as those derived via orthogonal polynomials via the legendre memory. unit (LMU) or highly predictive polynomial order (HiPPO) formalisms. During training by the training module 222, gain may be initially set as G=0, such that it promotes stability, and G may be slowly increased to promote greater adaption to the data for the network. Alternatively, the gain G may be made trainable, potentially with a smaller learning rate.

Various other means may be implemented by the training module 222 to train the modules 200-208. For example, the parallel scan technique is an available option. However, parallel scan suffers from limited software support. Proprietary libraries, such as the compute unified device architecture (CUDA), are generally required to perform parallel scan efficiently. An alternative to parallel scan for processing recurrent updates of an SSM implemented by the modules 200-208 uses mainly cumulative sums, an operation supported efficiently in almost every numerical library.

In some embodiments for implementing the cumulative sums, Āₜ may be a diagonal matrix, for which, for the sake of simplicity, only the recurrent updates of a single state element may be considered. In other words, a single state xₜ, a single projected input uₜ, and the state update factor aₜ, with the recurrence relation of:

$${x}_{t} = {a}_{t} {x}_{t - 1} + {u}_{t}$$

The cumulative product of a may be:

$${a}_{t}^{*} = {\prod }_{{t}^{′} = 1}^{t} {a}_{{t}^{′}}$$

and the cumulative state of x may be:

$${x}_{t}^{*} = {\sum }_{{t}^{′} = 1}^{t} \frac{{x}_{{t}^{′} - 1}}{{a}_{{t}^{′} - 1}^{*}}$$

The internal state may be the product of the cumulative product of a and the cumulative state of x:

$$x = {x}_{t}^{*} \times {a}_{t}^{*}$$

Expressed in the log space, which may have the benefit of improved numerical stability, the cumulative product of a, the cumulative state of x, and internal state may be:

$$log ( {a}_{t}^{*} ) = {\sum }_{{t}^{′} = 1}^{t} log ( {a}_{{t}^{′} - 1}^{*} )$$

$$log ( {x}_{t}^{*} ) = log sum {exp}_{{t}^{′} = 1}^{t} [ log ( {u}_{{t}^{′} - 1} ) - log ( {a}_{{t}^{′} - 1}^{*} ) )$$

$$log ( {x}_{t} ) = log ( {x}_{t}^{*} ) - log ( {a}_{t}^{*} )$$

where logsumexp is the logarithmic equivalence of taking a sum in log space.

Cumulative sums may enable both efficient parallel implementation (for training) and efficient streaming implementation (for inference). In addition, for streaming or sequential summation, especially when a neural network including interconnected SSM systems is quantized for mobile deployment, algorithms such as Kahan summation may be used to reduce roundoff errors. This makes the cumulative sum method easily supported for both training and inference with standard software libraries.

Negative inputs 210 may be easily handled by performing the logsumexp operation in the complex domain. However, certain software and hardware backends (e.g. CUDA for NVIDIA GPUs) do not have native support for complex operations. To accommodate limitations of existing software and hardware a “doubling” strategy may enable working in the real space.

“Positive” and “negative” doubling of the input 210 may be expressed as:

$${u}^{+} = \{ - u if u < 02 u if u \geq 0 {u}^{-} = \{ - 2 u if u < 0 u if u \geq 0$$

Both u⁺ and u⁻ may be positive. To prevent taking the logs of zeros, a small lower bound as u⁺=max (u⁺, ϵ) and u⁻=max (u⁻, ϵ) may be enforced.

A check that the original input is given approximately by

$$u = {u}^{+} - {u}^{-}$$

may be implemented. Linearity of the interconnected SSM system may enable both positive and negative parts of the input 210 through the scan operations in the log space separately, yielding x⁺ and x⁻ outputs, which may enable recovery of the original output x=x⁺−x⁻. The scan operations may be performed fully in real space if the input 210 is positive for all t.

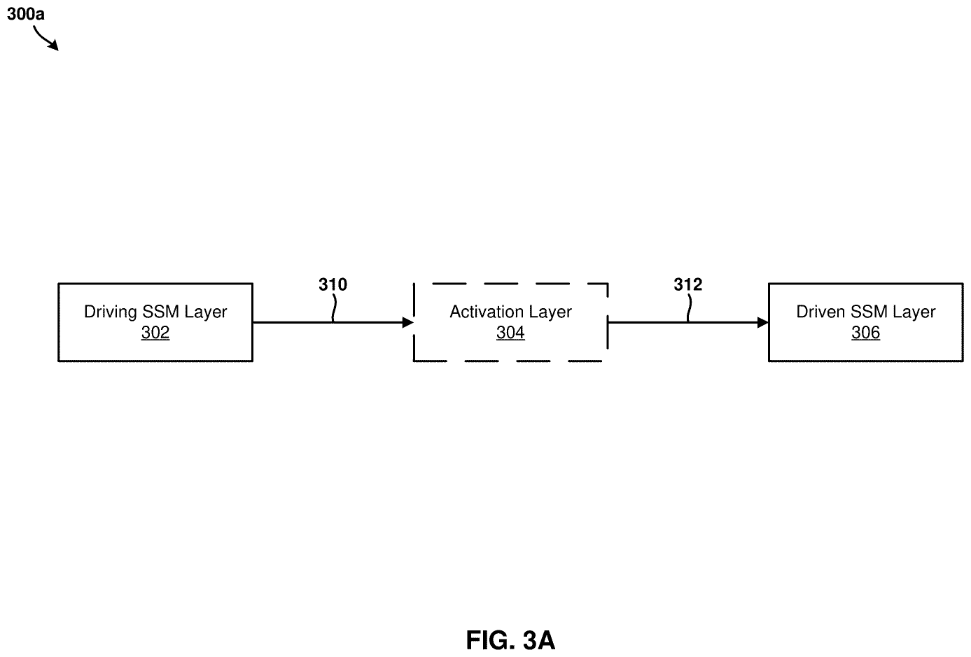

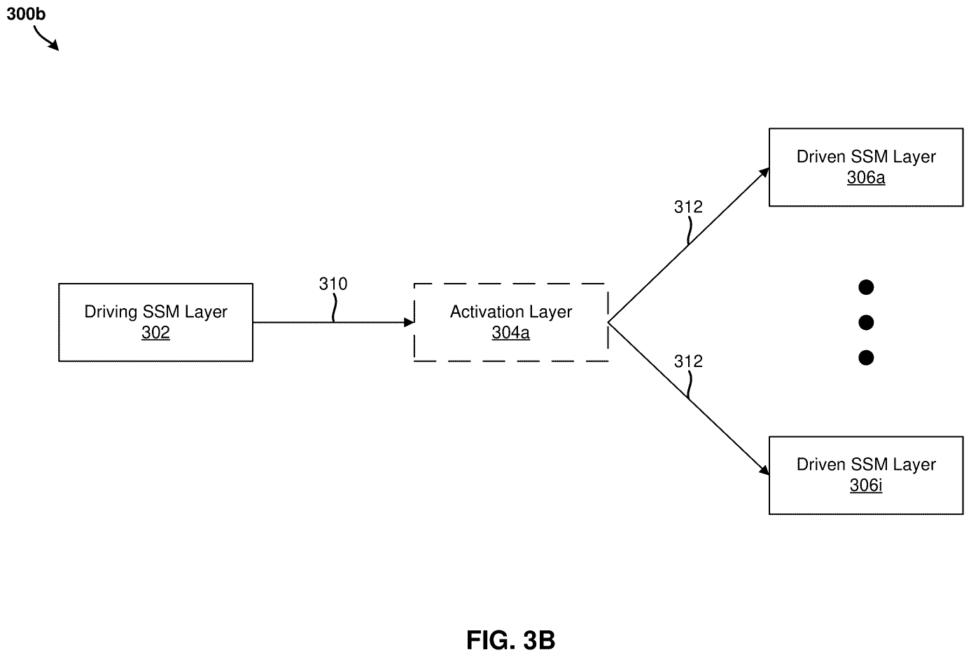

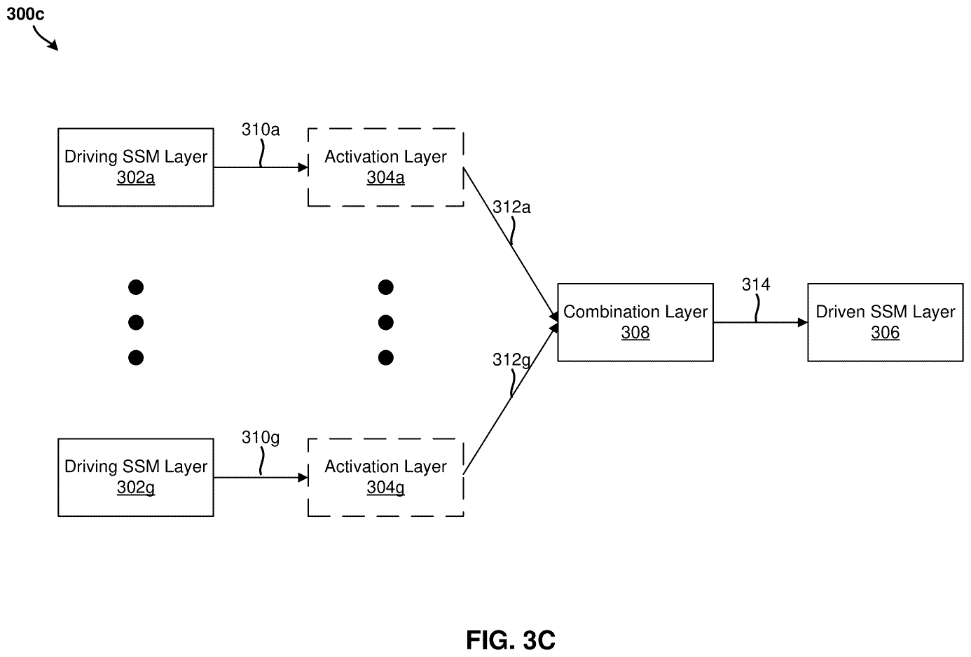

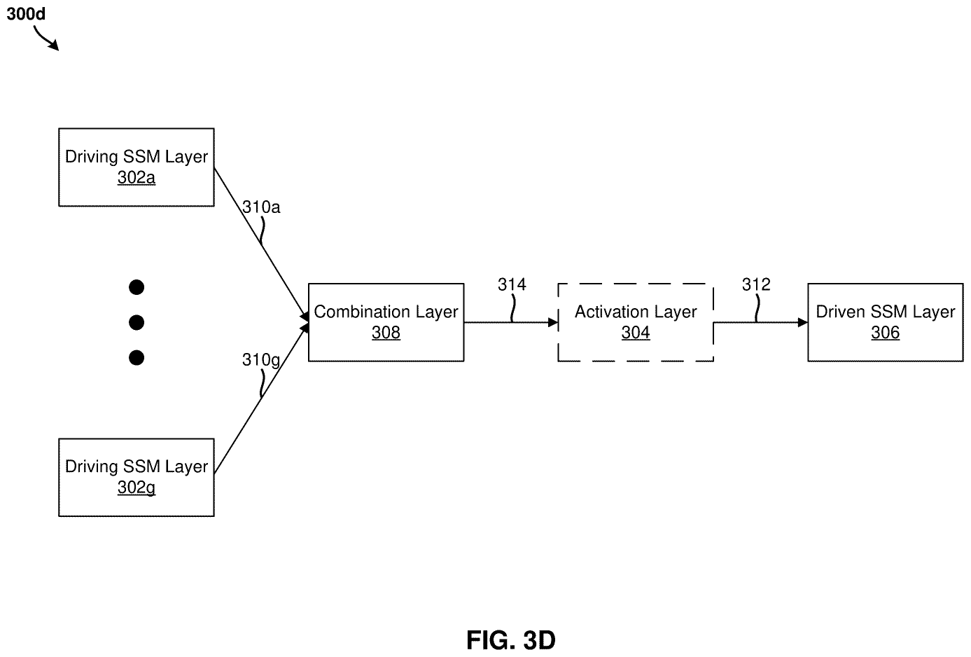

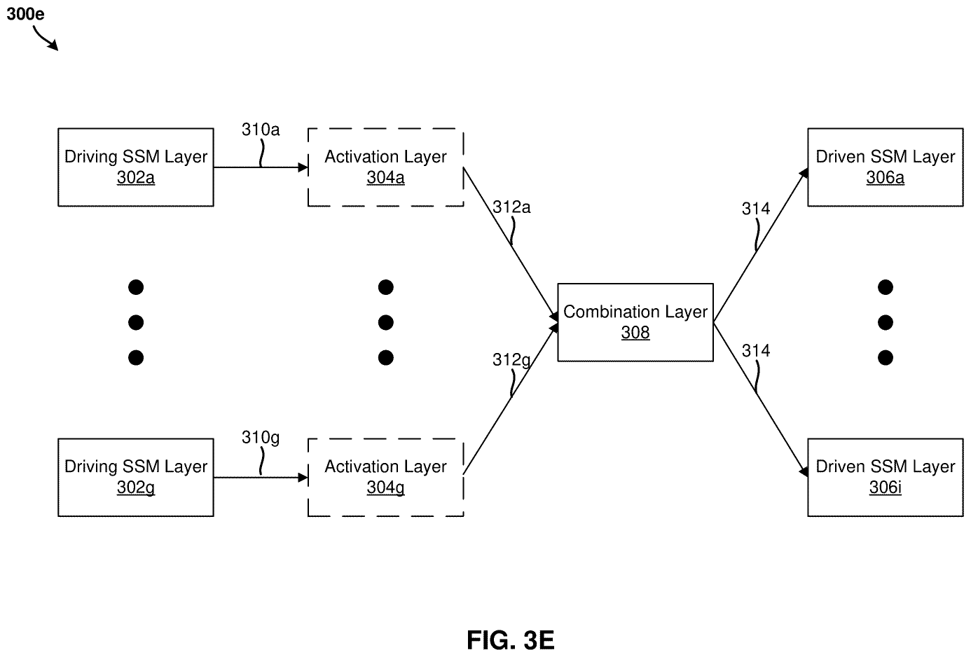

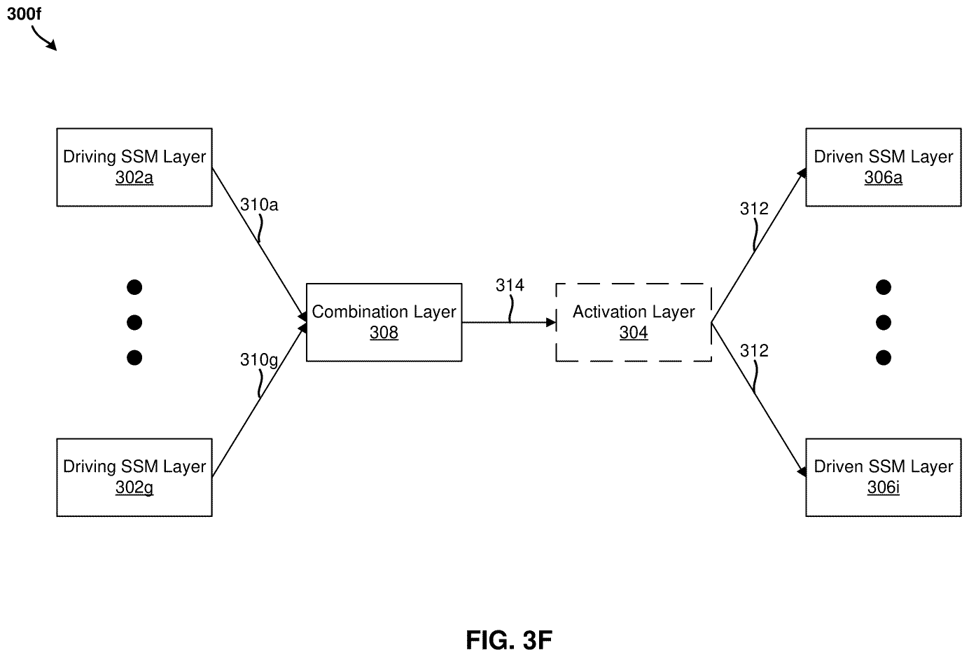

FIGS. 3A-3F illustrate interconnected SSM systems 300a-300f in accordance with some embodiments. The interconnected SSM systems 300a-300f may be configured as hardware integral to or separate from the SoC 100 or software stored on memory 136 and executed by a processing system, including one or more processors 130-132. In some embodiments, an interconnected SSM system may include any combination of one or more of the interconnected SSM systems 300a-300f. The interconnected SSM systems 300a-300f may include at least one driving SSM layer 302 and at least one driven SSM layer 306. A driving SSM layer 302 may be configured to generate outputs (e.g., y′ₜ) that may be data-driven inputs to a driven SSM layer 306. Providing these outputs of the driving SSM layer 302 as inputs to the driven SSM layer 306 configure the driven SSM layer 306 to be data-driven. The driving SSM layer 302 may be executed by the driving SSM module 200 and any combination of the modules 202-208 include therein.

A feedforward connection configuration of the interconnected SSM systems 300a-300f may connect an output of the driving SSM layer 302 and a control input of the SSM layer 306. The driven SSM layer 306 may be configured to make inferences based on the outputs of the driving SSM layer 302. A lateral connection configuration of the interconnected SSM systems 300a-300f may connect the output of the driving SSM layer 302 and a parameterization input of the driven SSM layer 306. The driven SSM layer 306 may be configured to make inferences based control inputs to the driven SSM layer 306 using parameters, such as weights, based on the outputs of the driving SSM layer 302.

In some embodiments, the driving SSM layer 302 and the driven SSM layer 306 may be directly connected. The outputs of the driving SSM layer 302 may be received by the driven SSM layer 306 without any alteration. In some embodiments, at least one optional activation layer 304, such as a nonlinear activation layer, may connect the driving SSM layer 302 and the driven SSM layer 306. The outputs of the driving SSM layer 302 may be altered, or transformed, by the activation layer 304 and outputs of the activation layer 304 may be received by the driven SSM layer 306. In some embodiments, the activation layer 304 may be referred to as a lateral activation layer and may configured to execute the activation function g discussed further herein.

Any number of driving SSM layers 302 may be connected with any number of driven SSM layers 306. For example, as illustrated in FIG. 3A, the interconnected SSM system 300a may include a one-to-one connection of one driving SSM layer 302 and one driven SSM layer 306. The driving SSM layer 302 may generate an output 310 that may be received by and input to the driven SSM layer 306. In some embodiments, the driving SSM layer 302 and the driven SSM layer 306 may be connected via an activation layer 304. The driving SSM layer 302 may generate the output 310 that may be received by and input to the activation layer 304. An output 312 of the activation layer 304 may be received by and input to the driven SSM layer 306. The output 312 of the activation layer 304 may be generated by a transformation of the output 310.

For another example, as illustrated in FIG. 3B, the interconnected SSM system 300b may include a one-to-many connection of one driving SSM layer 302 and multiple driven SSM layer 306a-306i, where “i” may be an integer greater than one. The driving SSM layer 302 may generate an output 310 that may be received by and input to the driven SSM layers 306a-306i. In some embodiments, the driving SSM layer 302 and the driven SSM layers 306a-306i may be connected via an activation layer 304. The driving SSM layer 302 may generate the output 310 that may be received by and input to the activation layer 304. An output 312 of the activation layer 304 may be received by and input to the driven SSM layers 306a-306i. The output 312 of the activation layer 304 may be generated by a transformation of the output 310. In some embodiments, the interconnected SSM system 300b may include any combination of the driving SSM layer 302 and the driven SSM layers 306a-306i via direct connections and via the activation layer 304.

For another example, as illustrated in FIG. 3C, the interconnected SSM system 300c may include a many-to-one connection of multiple driving SSM layers 302a-302g, where “g” may be an integer greater than one, and one driven SSM layer 306. A combination layer 308 may connect the driving SSM layers 302a-302g and the driven SSM layer 306. The driving SSM layers 302a-302g may generate multiple outputs 310a-310g that the combination layer 308 may combine by any combination of operations, such as mathematical, logical, bitwise, etc. An output 314, of the combination of the outputs 310a-310g, from the combination layer 308 may be received by and input to the driven SSM layer 306.

In some embodiments, the driving SSM layers 302a-302g and the driven SSM layer 306 may be connected via multiple activation layers 304a-304g. The driving SSM layers 302a-302g may generate the outputs 310a-310g that may be received by and input to the activation layers 304a-304g. Multiple outputs 312a-312g of the activation layers 304a-304g may be generated by transformations of the outputs 310a-310g. The outputs 312a-312g of the activation layers 304a-304g may be combined by the combination layer 308. An output 314, of the combination of the outputs 312a-312g, from the combination layer 308 may be received by and input to the driven SSM layer 306. In some embodiments, the interconnected SSM system 300c may include any combination of connections of the driving SSM layers 302a-302g and the driven SSM layer 306 via the combination layer 308 and additionally via the activation layers 304a-304g.

For another example, as illustrated in FIG. 3D, the interconnected SSM system 300d may include a many-to-one connection of multiple driving SSM layers 302a-302g, where “g” may be an integer greater than one, and one driven SSM layer 306. A combination layer 308 may connect the driving SSM layers 302a-302g and the driven SSM layer 306. The driving SSM layers 302a-302g may generate multiple outputs 310a-310g that the combination layer 308 may combine by any combination of operations, such as mathematical, logical, bitwise, etc. An output 314, of the combination of the outputs 310a-310g, from the combination layer 308 may be received by and input to the driven SSM layer 306.

In some embodiments, the driving SSM layers 302a-302g and the driven SSM layer 306 may be connected via an activation layer 304. The output 314, of the combination of the outputs 310a-310g, from the combination layer 308 may be received by and input to the activation layer 304. An output 312 of the activation layer 304 may be generated by transformations of the output 314. The output 312 of the activation layer 304 may be received by and input to the driven SSM layer 306.

For another example, as illustrated in FIG. 3E, the interconnected SSM system 300e may include a many-to-many connection of multiple driving SSM layers 302a-302g, where “g” may be an integer greater than one, and multiple driven SSM layers 306a-306i, where “i” may be an integer greater than one. A combination layer 308 may connect the driving SSM layers 302a-302g and the driven SSM layers 306a-306i. The driving SSM layers 302a-302g may generate multiple outputs 310a-310g that the combination layer 308 may combine by any combination of operations, such as mathematical, logical, bitwise, etc. An output 314, of the combination of the outputs 310a-310g, from the combination layer 308 may be received by and input to the driven SSM layers 306a-306i.

In some embodiments, the driving SSM layers 302a-302g and the driven SSM layers 306a-306i may be connected via multiple activation layers 304a-304g. The driving SSM layers 302a-302g may generate the outputs 310a-310g that may be received by and input to the activation layers 304a-304g. Multiple outputs 312a-312g of the activation layers 304a-304g may be generated by transformations of the outputs 310a-310g. The outputs 312a-312g of the activation layers 304a-304g may be combined by the combination layer 308. An output 314, of the combination of the outputs 312a-312g, from the combination layer 308 may be received by and input to the driven SSM layers 306a-306i. In some embodiments, the interconnected SSM system 300e may include any combination of connections of the driving SSM layers 302a-302g and the driven SSM layers 306a-306i via the combination layer 308 and additionally via the activation layers 304a-304g.

For another example, as illustrated in FIG. 3F, the interconnected SSM system 300f may include a many-to-many connection of multiple driving SSM layers 302a-302g, where “g” may be an integer greater than one, and multiple driven SSM layers 306a-306i, where “i” may be an integer greater than one. A combination layer 308 may connect the driving SSM layers 302a-302g and the driven SSM layers 306a-306i. The driving SSM layers 302a-302g may generate multiple outputs 310a-310g that the combination layer 308 may combine by any combination of operations, such as mathematical, logical, bitwise, etc. An output 314, of the combination of the outputs 310a-310g, from the combination layer 308 may be received by and input to the driven SSM layers 306a-306i.

In some embodiments, the driving SSM layers 302a-302g and the driven SSM layers 306a-306i may be connected via an activation layer 304. The output 314, of the combination of the outputs 310a-310g, from the combination layer 308 may be received by and input to the activation layers 304a-304g. An output 312 of the activation layer 304 may be generated by transformations of the output 314. The output 312 of the activation layer 304 may be received by and input to the driven layers 306a-306i.

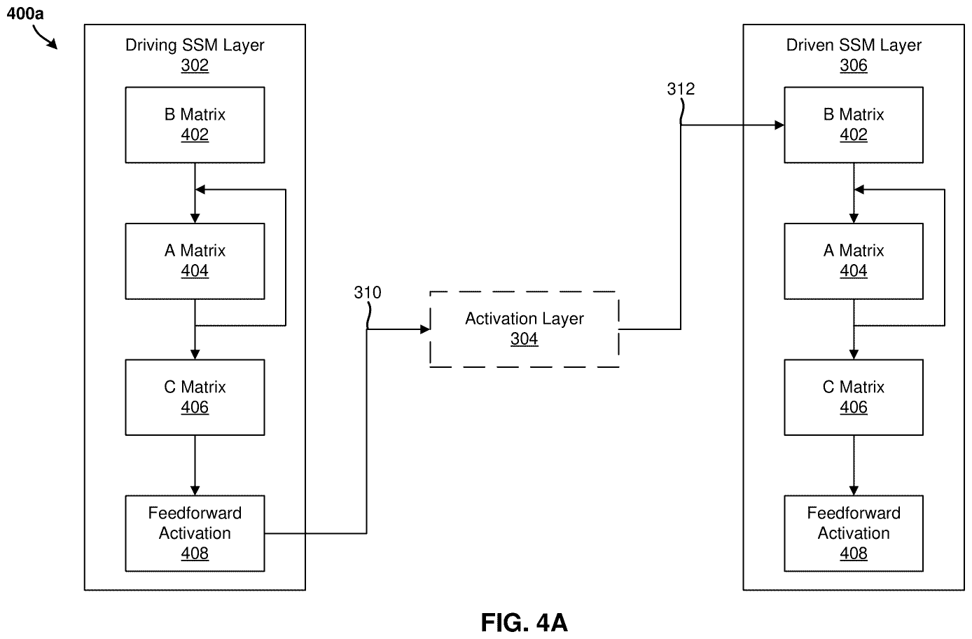

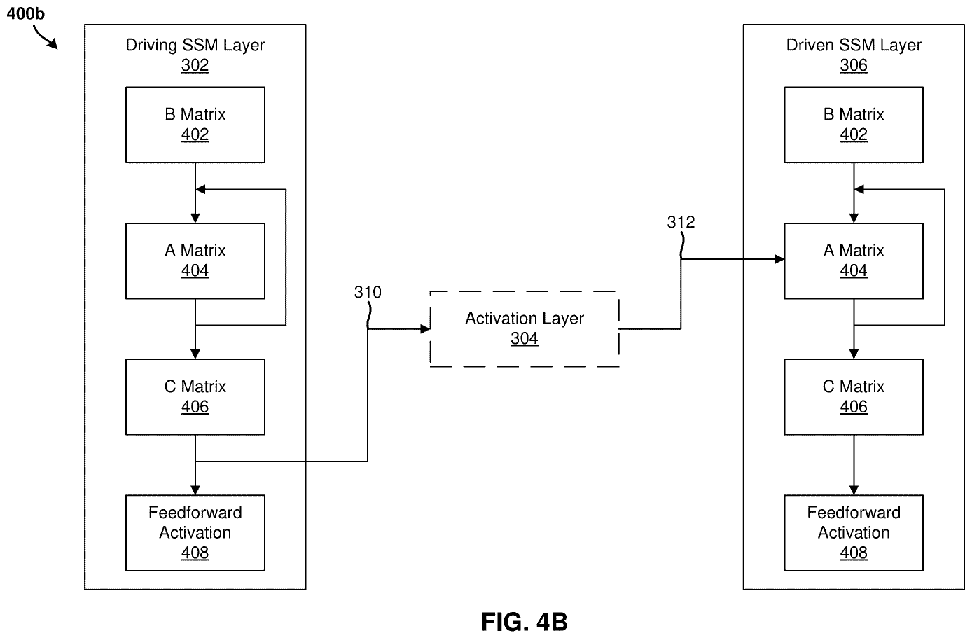

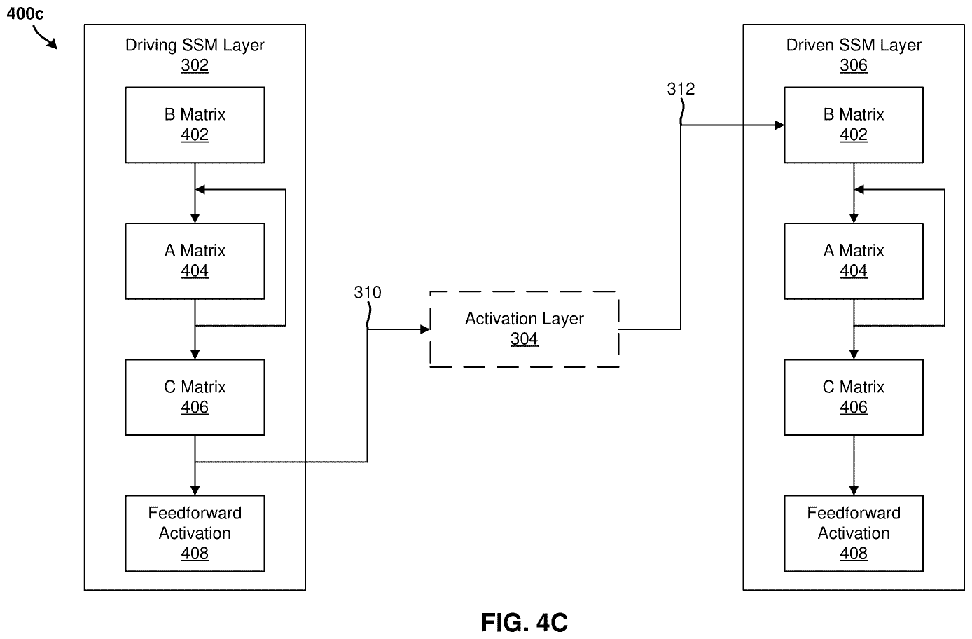

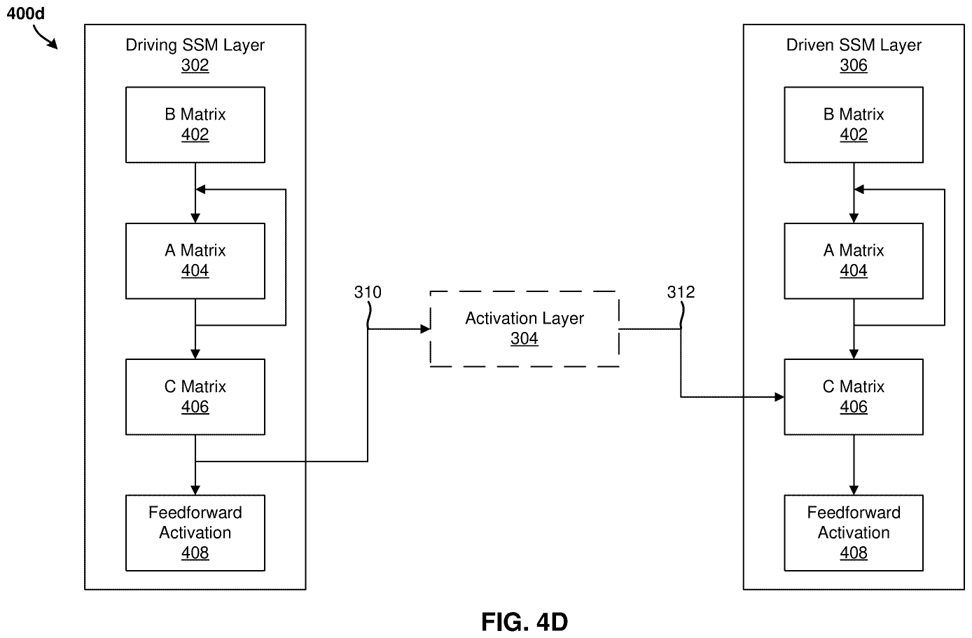

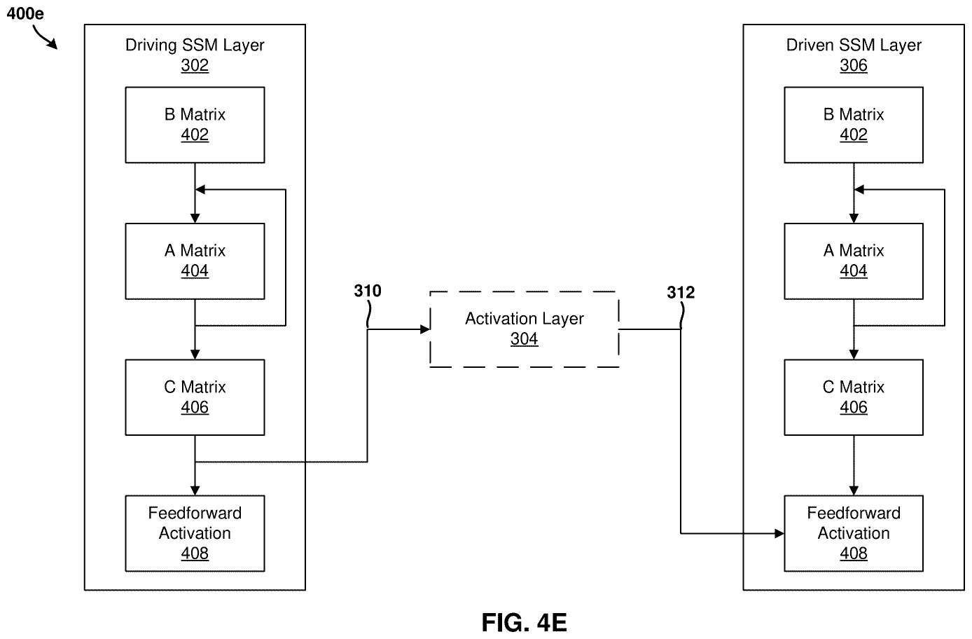

FIGS. 4A-4E illustrate interconnected SSM systems 400a-400e in which the driving SSM layer 302 drives components of the driven SSM layer 306 in accordance with some embodiments. The interconnected SSM systems 400a-400e are illustrated in one-to-one configurations for brevity and clarity. Embodiments may include any combination of the interconnected SSM systems 400a-400e similar to the configurations of the interconnected SSM systems 300a-300f, including any combination of one-to-one, one-to-many, many-to-one, and many-to-many configurations of the driving SSM layer 302 and the driven SSM layer 306. Embodiments may also include corresponding activations layers 304 and combination layers (not shown for brevity and clarity; e.g., combination layer 308) as described for the interconnected SSM systems 300a-300f.

The driving SSM layer 302 and the driven SSM layer 306 may include a B matrix 402, and A matrix 404, a C matrix 406, and a feedforward activation function 408. In various embodiments, an output 310 of driving SSM layer 302 may be output to the driven SSM layer 306 to drive components 402-408 of the driven SSM layer 306.

The interconnected SSM system 400a illustrated in FIG. 4A is an example of a feedforward connection of the driving SSM layer 302 and the driven SSM layer 306. The output 310 of the driving SSM layer 302 including the output of the feedforward activation function 408 may be provided as an input to the driven SSM layer 306, which may implement conventional SSM operations based on the output 310. In some embodiments, the activation layer 304 may transform the output 310 and generate an output 312 of the activation layer 304. The output 312 of the activation layer 304 may be provided as an input to the driven SSM layer 306, which may implement conventional SSM operations based on the output 312.

The interconnected SSM systems 400b-400e illustrated in FIGS. 4B-4E are examples of lateral connections of the driving SSM layer 302 and the driven SSM layer 306. The outputs 310 of the driving SSM layer 302 including the C matrix 406 or the outputs 312 of the activation layer 304 may be provided as an input to the driven SSM layer 306, which may parameterize the components 402-408 of the driven SSM layer 306. In some embodiments, parameterization may include using the output 310 of the driving SSM layer 302 based on the C matrix 406 as weights or to influence weights for generating the component 402-408 of the driven SSM layer 306. In some embodiments, parameterization may include using the output 312 of the activation layer 304 based on the output 310 of the driving SSM layer 302 based on the C matrix 406 as weights or to influence weights for generating the component 402-408 of the driven SSM layer 306.

For example, in the interconnected SSM system 400b, a lateral connection allows the driving SSM layer 302 to parameterize the A matrix 404 of the driven SSM layer 306. Outputs of the driving SSM layer 302 may directly update the A matrix or may first be transformed by an activation layer before parameterization. This configuration may allow for dynamic, data-driven updates to model parameters. As another example, the interconnected SSM system 400c illustrated in FIG. 4C is a lateral connection of the driving SSM layer 302 and the driven SSM layer 306 configured to parameterize the B matrix of 402 of the driven SSM layer 306. For another example, the interconnected SSM system 400d illustrated in FIG. 4D is a lateral connection of the driving SSM layer 302 and the driven SSM layer 306 configured to parameterize the C matrix 406 of the driven SSM layer 306. For another example, the interconnected SSM system 400e illustrated in FIG. 4E is a lateral connection of the driving SSM layer 302 and the driven SSM layer 306 configured to parameterize the feedforward activation function 408 of the driven SSM layer 306.

In embodiments of many-to-one or one-to-many configurations of the driving SSM layer 302 and the driven SSM layer 306, a combination layer may combine any combination of one or more outputs 310, 312. In some embodiments, an output of the combination layer may be provided to and used by the driven SSM layer 306 in a manner similar to the outputs 310, 312 described for the interconnected SSM systems 400a-400e. In some embodiments, the output of the combination layer may be provided to and used by the activation layer 304 to generate the output 312. The output 312 of the activation layer may be provided to and used by the driven SSM layer 306 in a similar manner as the output 312 described for the interconnected SSM systems 400a-400e.

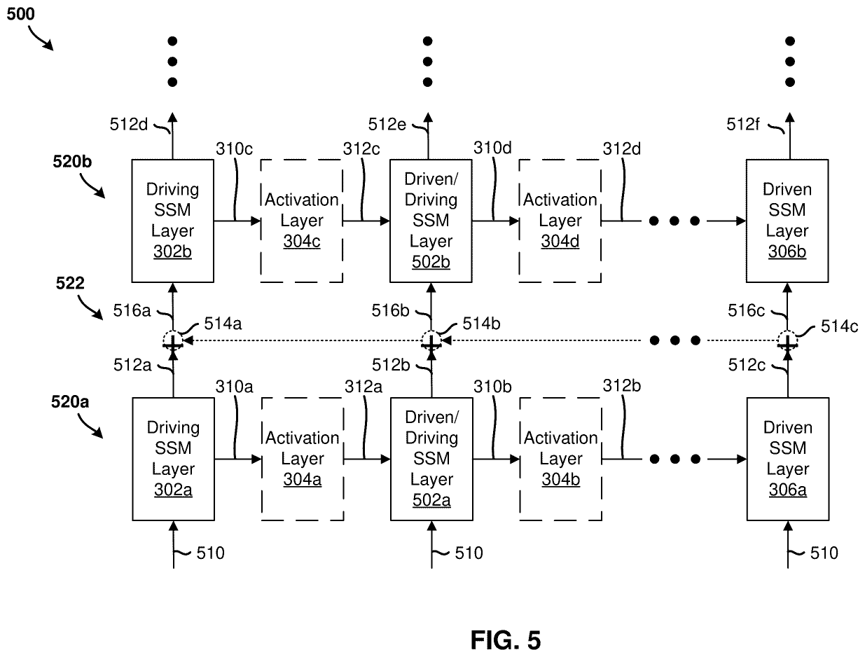

FIG. 5 illustrates an example of an interconnected SSM network 500 in accordance with some embodiments. The interconnected SSM network 500 may include subsystems that dynamically configure the state matrices of the corresponding main systems. This hierarchical framework may allow for flexible configurations, including one-to-one, one-to-many, and many-to-one relationships. Subsystems may act as controllers, adjusting parameters of main systems based on contextual or hierarchical dependencies in the data. For example, subsystems in lower network layers may drive the state-space matrices of main systems in higher layers to allow for nuanced modeling of long-range temporal patterns in language modeling or multi-layered feature extraction in vision systems.

In many-to-many configurations, multiple subsystems may jointly influence main systems through weighted connections to provide distributed control. In some embodiments, recursive connections may also be implemented in which the output of a driven SSM feeds back into the driving SSM to refine parameter updates iteratively. Such recursive designs may provide dynamic adaptation and enhance flexibility for tasks such as real-time speech synthesis, dynamic scene understanding, and multi-modal processing.

Some embodiments may use advanced numerical methods to maintain stability during backpropagation. These embodiments may use logarithmic-domain computations to reduce overflow and underflow risks, and Kahan summation to mitigate rounding errors during inference, particularly in quantized implementations. Such techniques may help ensure robust training and inference on large-scale data or when operating under hardware constraints.

With reference to FIG. 5, the interconnected SSM network 500 may include multiple interconnected SSM systems 300a-300f and 400a-400e. In some embodiments, any number and combination of interconnected SSM systems 300a-300f and 400a-400e or driving SSM layers 302 and driven SSM layers 306, may be connected in feedforward or lateral connections. For example, a driven/driving SSM layer 502a, 502b may be connected between a driving SSM layer 302a, 302b and a driven SSM layer 306a, 306. The driven/driving SSM layer 502a, 502b may be configured as a driven SSM layer in relation to the driving SSM layer 302a, 302b and as a driving SSM layer in relation to the driven SSM layer 306a, 306. An interconnected SSM network may include any number of driven/driving SSM layers 502a, 502b connected to other driven/driving SSM layers 502a, 502b between the driving SSM layer 302a, 302b and the driven SSM layer 306a, 306. In various embodiments, some or all of the driving SSM layers 302a, 302b, the driven SSM layers 306a, 306b, or the driven/driving SSM layers 502a, 502b connected in lateral connections may be on the same or across two or more different levels of the interconnected SSM network.

The interconnected SSM network 500 illustrated in FIG. 5 is a simplified, non-limiting example for clarity and brevity. Various other configurations of interconnected SSM networks may be implemented, such as those further described herein. The driving SSM layer 302a, any number of driven/driving SSM layers 502a, and the driven SSM layer 306a may be connected in lateral connections forming a level 520a of the interconnected SSM network 500. Similarly, the driving SSM layer 302b, any number of driven/driving SSM layers 502b, and the driven SSM layer 306b may be connected in lateral connections forming a level 520b of the interconnected SSM network 500. The driving SSM layers 302a, 302b and the driven/driving SSM layers 502a, 502b may provide the outputs 310a-310d to the driven/driving SSM layers 502a, 502b and the driven SSM layers 306a, 306b. The driven/driving SSM layers 502a, 502b and the driven SSM layers 306a, 306b may be parameterized by the outputs 310a-310d.

In some embodiments, activation layers 304a-304d may be connected between the SSM layers 302a, 302b, 502a, 502b, 306a, 306b. The activation layers 304a, 304b, 304c, 304d may receive the outputs 310a, 310b, 310c, 310d from the driving SSM layers 302a, 302b and the driven/driving SSM layers 502a, 502b and provide outputs 312a-312d to the driven/driving SSM layers 502a, 502b and the driven SSM layers 306a, 306b. The driven/driving SSM layers 502a, 502b and the driven SSM layers 306a, 306b may be parameterized by the outputs 312a-312d.

The SSM layers 302a, 502a, 306a of the level 520a may receive an input 510. Lateral outputs 310a, 310b configured for parameterizing the SSM layers 502a, 306a may be generated by the SSM layers 302a, 502a based on the inputs 510. In some embodiments, the lateral outputs 310a, 310b may be transformed by activation layers 304a, 304b and lateral outputs 312a, 312b may be provided to and configured for parameterizing the SSM layers 502a, 306a. The SSM layers 302a, 502a, 306a of the level 520a may be connected to the SSM layers 302b, 502b, 306b of the level 520b in feedforward connections. Feedforward outputs 512a-512c configured as feature inputs to the SSM layers 302b, 502b, 306b may be generated by the SSM layers 302a, 502a, 306a based on the inputs 510 and the lateral outputs 310a, 310b or lateral outputs 312a, 312b.

The SSM layers 302b, 502b, 306b of the level 520b may receive the feedforward outputs 512a-512c as inputs. In some embodiments, an accumulation layer 522 may connect the levels 520a, 520b. The accumulation layer 522 may include accumulators 514a-514c that may receive and accumulate the feedforward outputs 512a-512c generating accumulated outputs 516a-516c. The accumulated outputs 516a-516c may be input to the SSM layers 302b, 502b, 306b. Based on the feedforward outputs 512a-512c or the accumulated outputs 516a-516c as inputs, the SSM layers 302b, 502b, 306b may generate lateral outputs 310c, 310d configured for parameterizing the SSM layers 502b, 306b. In some embodiments, the lateral outputs 310c, 310d may be transformed by activation layers 304c, 304d and lateral outputs 312c, 312d may be provided to and configured for parameterizing the SSM layers 502b, 306b. The SSM layers 302b, 502b, 306b of the level 520b may generate feedforward outputs 512d-512f based on the feedforward outputs 512a-512c or the accumulated outputs 516a-516c as inputs and the lateral outputs 310c, 310d or the lateral outputs 312c, 312d.

The interconnected SSM network 500 may significantly enhance the performance of large language models (LLMs) by capturing long-range dependencies and context-sensitive patterns. For example, the hierarchical configuration of subsystems and main systems may allow the model to resolve ambiguities in natural language by dynamically adjusting state-space matrices based on prior inputs. Similarly, in audio processing, the system may dynamically suppress noise and enhance speech signals by tailoring matrix parameters to the frequency characteristics of the input. In vision applications, the driving mechanisms may allow the model to infer relationships between distant objects in a scene to improve accuracy in tasks such as object tracking or autonomous navigation.

In some embodiments, the interconnected SSM network 500 may implement or use quantization strategies to further enhance the interconnected SSM system for deployment on edge devices. In some embodiments, dyadic fixed-point quantization schemes may reduce the computational complexity of state updates while maintaining numerical precision. These schemes may include shared quantizers for state matrices to reduce rounding errors during operations. For example, input projections and state updates may be fused into a single computation step, allowing intermediate results to be retained in fast-access memory, such as SRAM or on-chip buffers. This may allow more efficient execution of SSM operations on resource-constrained platforms and preserve the accuracy of the model.

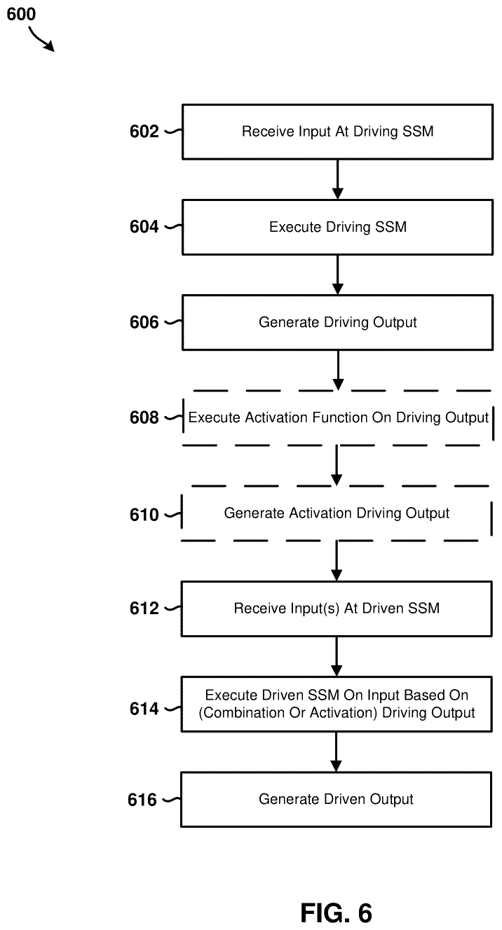

FIG. 6 is a process flow diagram illustrating an example flow/method 600 for implementing interconnected SSMs configured for a driving SSM driving a driven SSM in accordance with some embodiments. The method 600 may be performed in a computing device by a processing system encompassing one or more processors (e.g., processors 120-132, etc.), components, or subsystems discussed in this application. The processing system may execute processing system-executable instructions (e.g., modules 202-208) stored on a non-transitory processor-readable medium (e.g., memory 136).

In block 602, the processing system may receive an input 210, 510, 212, 214. In some embodiments, the input 210, 510 may be data external to a driving SSM layer 302, 502 and may include a portion of a larger data set for which the included data varies based on time, such as audio, vital signs, language, etc. In some embodiments, the input 212, 214 may be data internal to the operation of the driving SSM layer 302, 502, such as state inputs or state variables. In some embodiments, receiving the input 210, 510 may include the processing system executing specific functions of the driving SSM module 200, the B matrix module 202, the A matrix module 204, or the C matrix module 206.

In block 604, the processing system may execute the driving SSM layer 302, 502. Executing the driving SSM layer 302, 502 may include executing any one or more of the functions of the driving SSM layer 302, 502 that generate an output 212, 214, 218, 220, 310, 512 that may be used internally or externally to the driving SSM layer 302, 502. In some embodiments, executing the driving SSM layer 302, 502 may include the processing system executing specific functions of the driving SSM module 200, the B matrix module 202, the A matrix module 204, or the C matrix module 206.

In block 606, the processing system may generate a driving output 310. The driving output may include an output 212, 214, 218, 220 of any of the functions of the driving SSM layer 302, 502 and may be configured to be used as an input to a driven SSM layer 306, 502 in a feedforward connection or to parameterize the driven SSM layer 306, 502 in a lateral connection. In some embodiments, generating the driving output 310 may include the processing system executing specific functions of the driving SSM module 200, the B matrix module 202, the A matrix module 204, the C matrix module 206, or the feedforward module 208.

In optional block 608, the processing system may execute an activation function on the driving output 310. The activation function may be implemented on the driving output 310 in a feedforward connection between the driving SSM layer 302, 502 and the driven SSM layer 306, 502 or a lateral connection between the driving SSM layer 302, 502 and the driven SSM layer 306, 502. In some embodiments, the activation function may be the lateral activation function g discussed further herein. The activation function may result in generating an activation output 312. In some embodiments, executing the activation function on the driving output 310 may include the processing system executing specific functions of the activation function layer 304.

In some embodiments, the processing system may execute activation functions to transform outputs from driving SSM layers. For example, the processing system may perform operations using bounded activation functions, such as the hyperbolic tangent (tanh) or rectified linear unit (ReLU), to constrain the dynamic range of parameter updates and provide numerical stability. In some embodiments, the processing system may implement trainable activation functions, allowing the network to modify activation behaviors based on task-specific requirements. The processing system may also perform operations using a combination of basis functions to represent an activation layer (e.g., to support a blend of linear and non-linear transformations). In addition, the processing system may retrieve precomputed activation values from lookup tables to reduce inference latency in resource-constrained environments.

In optional block 610, the processing system may generate activation driving outputs or combine an output 310, 312 with one or more other outputs 310, 312. The other outputs 310, 312 may be generated as described herein for blocks 602-608 by one or more other driving SSM layers 302, 502 or one or more other activation function layers 304 that may be part of an interconnected SSM system 300a-300f or part of an interconnected SSM network 500. Combining the outputs 310, 312 may be executed by any combination of operations, such as numerical, logical, bitwise, etc. The functions of combination of the outputs 310, 312 may result in generating a combined output 314. In some embodiments, combining the output 310, 312 with one or more other outputs 310, 312 may include the processing system executing specific functions of the combination layer 308.

In various embodiments, the operations of optional blocks 608, 610 may be executed in an opposite order. In other words, in optional block 610, the processing system may combine the driving output 310 with one or more other outputs 310, 312. Subsequently, in optional block 608, the processing system may execute an activation function on the combined output 314.

In block 612, the processing system may receive one or more inputs 210, 310, 312, 510. In some embodiments, the inputs may include a feedforward and/or a lateral output 312 from the driving SSM layer 302, 502. In some embodiments, the inputs may include that same input 210, 510 received by the driving SSM layer 302, 502 and the lateral output 312 from the driving SSM layer 302, 510. In some embodiments, the inputs received from the driving SSM layer 302, 510 may be activation outputs 312 or combined outputs 314 based on the feedforward and/or a lateral output 312. In some embodiments, receiving the one or more inputs 210, 310, 312, 510 may include the processing system executing specific functions of the driven SSM layer 306, 510.

In block 614, the processing system may execute the driven SSM layer 306, 502. Executing the driven SSM layer 306, 502 may include executing any one or more of the functions of the driven SSM layer 306, 502 parameterized based on the received one or more inputs 210, 310, 312, 510. In some embodiments, executing the driven SSM layer 306, 502 may include the processing system executing specific functions of the driven SSM layer 306, 502.

In block 616, the processing system may generate a driven output 512. Execution of the driven SSM layer 306, 502 parameterized based on the received one or more inputs 210, 310, 312, 510 may generate a data-driven output 512. The one or more inputs 210, 310, 312, 510 may be generated based on data inputs 210, 510 to the driver SSM layer 302, 502 causing the driven output 512 to be based on data input derived parameterizations. In some embodiments, generating the driven output 512 may include the processing system executing specific functions of the driven SSM layer 306, 502.

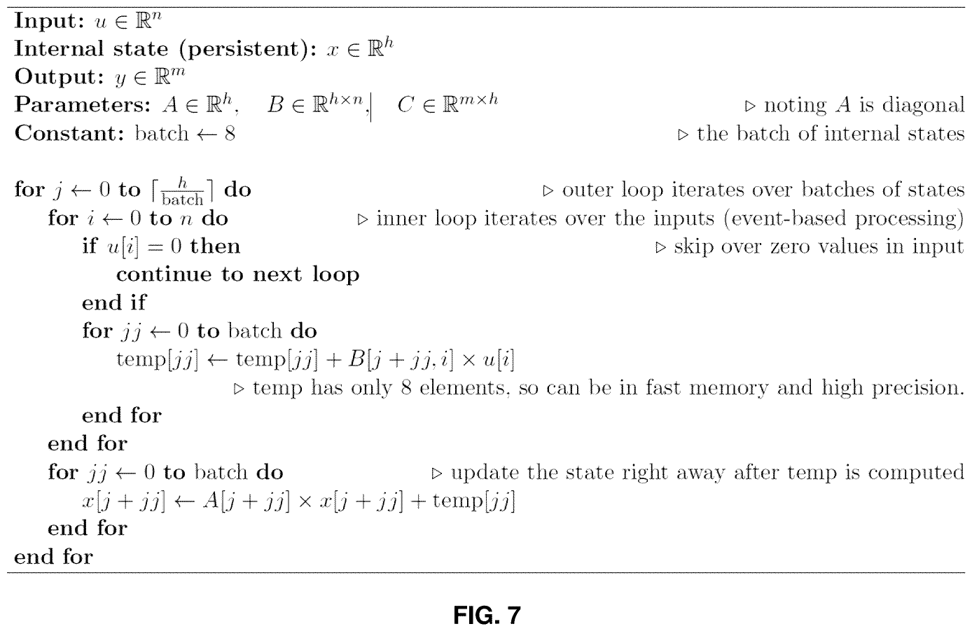

FIG. 7 illustrates an example pseudocode of event-based processing on sparse inputs and fusion of state updates in accordance with some embodiments. For a feedforward neural network, there may be an option to “pipeline” the layer operations. While a next layer is processing a previous frame of data, a current layer may begin processing at a current frame. In other words, the entire neural network may be treated as a queue where data may be streamed in and out, to greatly increase the throughput of the system. Pipelining may be applied in interconnected SSM systems 300a-300f for a driving SSM layer 302, 502 to drive a driven SSM layer 306, 502. The driven SSM layer 306, 502 may process a previous frame of data with a previous set of generated SSM matrices by the driving SSM layer 302, 502. Concurrently, the driving SSM layer 302, 502 may start generating a new set of SSM matrices based on the current frame of data.

An efficient hardware implementation of a state-update mechanism for the SSM layers 302, 306, 502 may be configured to achieve:

$${x}_{t + 1} = {A}^{‵} {x}_{t} + {B}^{‵} {u}_{t}$$

where the goal may be to update the internal states xₜ to xₜ₊₁ based on a projected input But and the state matrix Ā.

Naively, the full projected input tempₜ=\grave{B}uₜ may be computed, and the result may be temporarily stored in the host memory, which may cause unnecessary data movement. In various embodiments, both the input projection tempₜ=\acute{B}uₜ and state update operation Āxₜ+tempₜ may be performed in batches, meaning that a batch of the temporary result may be materialized, used, and freed on-chip without incurring data movement off-chip to the host. This is especially relevant if the state dimension h is large.

A nonlimiting example pseudocode of event-based processing with fused state update. An outer loop operates on and updates batches of states without transferring or storing any intermediate results (the temp variable is used following its computation). For each batch of states (an outer loop iteration), the inner loop iterates over all the inputs and skips over zero elements (event-based processing).

The example pseudo code for event-based processing includes nested loops having an outer loop and an inner loop. The outer loop may be configured for operating on and updating batches of states for an SSM layer 302, 306, 502. The outer loop may execute for a variable j of a value 0 to a ceiling of the state dimension h divided by a batch size value, which in this example is 8. The inner loop may execute for a variable i of a value 0 to n that represents a size of an input 210, 310, 312, 510, 512 to an SSM layer 302, 306, 502.

The event for the event based processing is having a non-zero value of the input 210, 310, 312, 510, 512. An if/then condition may execute for zero values of the input 210, 310, 312, 510, 512, triggering an exit of the inner loop. For zero values of the of the input 210, 310, 312, 510, 512, the if/then condition may trigger skipping execution of the exit of the inner loop to proceed to a loop for calculating the temp variable.

For values of 0 to the batch size for a variable jj, the temp variable may be calculated based on a previous temp variable added with a product of a value of the \grave{B} matrix and a value of the input 210, 310, 312, 510, 512. The temp values may be sufficiently small to maintain in fast, temporary memory. The temp value may be completed updating and the loop may be exited.

Following updating the temp value, the state of the SSM layer 302, 306, 502 may be calculated in a loop executed for values of 0 to the batch size for the variable jj. The state may be calculated based on a product of a value of the A matrix and a state value added with a temp value.

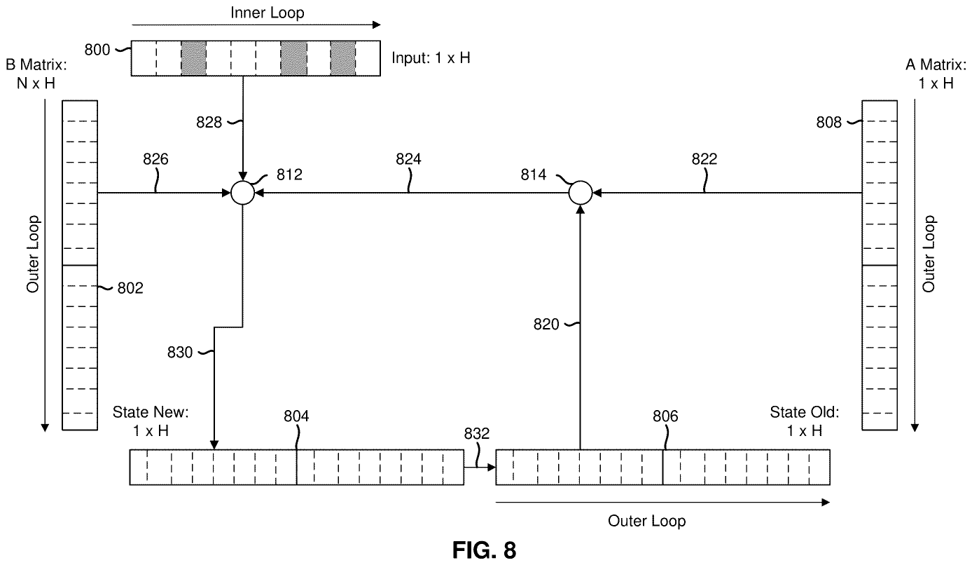

FIG. 8 illustrates an example of event-based processing on sparse inputs and fusion of state updates in accordance with some embodiments. The event-based processing may be configured to be executed as hardware integral to or separate from the SoC 100 or software stored on memory 136 and executed by a processing system, including one or more processors 120-132. Memories 800-808 may temporarily store values of the input data, the \grave{B} matrix, the À matrix, and new and old state data. In operation the memories 802, 806, 808 storing the \grave{B} matrix, old state data, and a matrix may be traversed in the direction of the illustrated arrows for each iteration of the outer loop of the pseudocode example illustrated in FIG. 7. The memory 800 storing the input data may be traversed in the direction of the illustrated arrow for each iteration of the inner loop of the pseudocode example.

The input u (e.g., input 210, 310, 312, 510, 512) to an SSM layer 302, 306, 502, in some embodiments may be a sparse vector. For example, a preceding activation layer 304 may promote sparsity (e.g., ReLU), or an intermediate sparsity promoting loss function may be applied to the input (e.g., L1 regularization). In such cases, it may be beneficial to skip over the zero elements of the input (shaded portions of the memory 800), such that only the nonzero elements are considered (unshaded portions of the memory 800). Processing the nonzero values and skipping the zero values of the input may be referred to as event-based processing, and is incredibly compute and energy efficient for highly sparse input vectors.

In some embodiments, the state matrix À may be diagonal, and all elements of the internal state x may be updated independently. Once an element of Bu is computed, the corresponding element of x may be updated from the memory 806 to the memory 804, without waiting for any other elements of x. This manner of updating the element of x enables updates of the elements of x to be parallelized and enable that intermediate results of Bu to be accumulated and kept in high precision in the SRAM (or even registers) rather than to be materialized and transferred to the main memory.

The pseudocode describing the combination of the event-based processing and kernel fusion of state updates for an SSM layer 302, 306, 502, may perform event-based processing and fused state updates with a low number of elements, such as approximately 8 elements, at a time in the outer loop. The outer loop may be parallelizable, such that on parallel hardware each worker (e.g. an SM on an Nvidia GPU) may independently process a different iteration of the loop.

In the nonlimiting example illustrated in FIG. 8 of a state update, an old state value 820 (xₜ) from the memory 806 may be multiplied by a corresponding value of the state matrix 822 (À) from the memory 808 by a first kernel 814 generating Àxₜ 824. A second kernel 812 may multiply a corresponding value of the \grave{B} matrix 826 (\grave{B}) from the memory 802 and a corresponding value of the input 828 (uₜ) generating But, adding Àxₜ 824 and But generating a new state value 830 (xₜ₊₁), and storing the new state value 830 to the memory 804. The second kernel 812 may add Àxₜ 824 and \grave{B}uₜ maintaining the values of Àxₜ 824 and \grave{B}uₜ in fast, short-term memory (e.g., registers, buffers, etc.). For a next time t, the new state values 830 stored in the memory 804 become old state values stored in the memory 806 as time progresses 832.

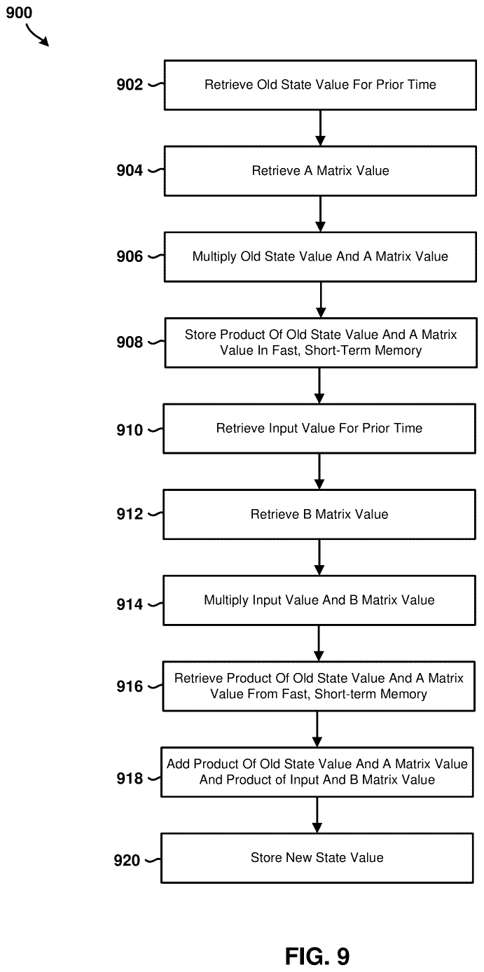

FIG. 9 is a process flow diagram illustrating an example flow/method 900 for implementing event-based processing on sparse inputs and fusion of state updates in accordance with some embodiments. The method 900 may be performed in a computing device by a processing system encompassing one or more processors (e.g., processors 120-132, etc.), components, or subsystems discussed in this application. The processing system may execute processing system-executable instructions (e.g., modules 202-208) stored on a non-transitory processor-readable medium (e.g., memory 136).

In block 902, the processing system may retrieve an old state value (e.g., old state value 820; xₜ) for an SSM layer 302, 306, 502 from the memory 806. The old state value may be for a prior time t and may have been generated by the SSM layer 302, 306, 502 based on an input (e.g., input 210, 310, 312, 510, 512) to the SSM layer 302, 306, 502 from an earlier time (uₜ₋₁). In some embodiments, retrieving the old state value for the SSM layer 302, 306, 502 from the memory 806 may include the processing system executing specific functions of the first kernel 814.

In block 904, the processing system may retrieve a value of a state matrix (e.g., state matrix 822; À) for an SSM layer 302, 306, 502 from the memory 808. In some embodiments, the value of the state matrix for a driving SSM layer 302, 502 may be a value of a fixed state matrix. In some embodiments, the value of the state matrix for a driven SSM layer 302, 502 may be a value of a parameterized state matrix based on an input (e.g., input 310, 312, 512) to the driven SSM layer 502, 306 from the driving SSM layer 302, 502 connected via a lateral connection. The input to the driven SSM layer may be generated by the driving SSM layer based on a data input (e.g., input 210, 510, 512). In some embodiments, retrieving the value of a state matrix for the SSM layer 302, 306, 502 from the memory 808 may include the processing system executing specific functions of the first kernel 814.

In block 906, the processing system may multiply the old state value from the memory 806 by the value of the state matrix from the memory 808. This multiplication operation may generate a product of the multiplied values Àxₜ (e.g., Àxₜ 824).). In some embodiments multiplying the old state value from the memory 806 by the value of the state matrix from the memory 808 may include the processing system executing specific functions of the first kernel 814.

In block 908, the processing system may store the product Àxₜ to a fast, short-term memory (e.g., registers, buffers, etc.). The product Àxₜ may have a number of elements, such as 8 elements, so that the size of the product Àxₜ may be stored on the fast, short-term memory and may not need to be stored to a slower, longer-term memory (e.g., memory 136). In some embodiments storing the product Àxₜ to the fast, short-term memory may include the processing system executing specific functions of the first kernel 814.

In block 910, the processing system may retrieve an input data value (e.g., value of the input 210, 310, 312, 510, 512, 828; uₜ) to the SSM layer 302, 306, 502 from the memory 800. The input data value may be for the prior time t. In some embodiments, retrieving the input data value to the SSM layer 302, 306, 502 from the memory 800 may include the processing system executing specific functions of the second kernel 812.

In block 912, the processing system may retrieve a value of a control matrix (e.g., control matrix 826; \grave{B}) for an SSM layer 302, 306, 502 from the memory 802. In some embodiments, the value of the control matrix for a driving SSM layer 302, 502 may be a value of a fixed control matrix. In some embodiments, the value of the control matrix for a driven SSM layer 302, 502 may be a value of a parameterized control matrix based on an input (e.g., input 310, 312, 512) to the driven SSM layer 502, 306 from the driving SSM layer 302, 502 connected via a lateral connection. The input to the driven SSM layer may be generated by the driving SSM layer based on a data input (e.g., input 210, 510, 512). In some embodiments, retrieving the value of the control matrix for the SSM layer 302, 306, 502 from the memory 802 may include the processing system executing specific functions of the second kernel 812.

In block 914, the processing system may multiply the input data value from the memory 800 by the value of the control matrix from the memory 802. This multiplication operation may generate a product of the multiplied values \grave{B}uₜ (e.g., \grave{B}uₜ). In some embodiments multiplying the input data value from the memory 800 by the value of the control matrix from the memory 802 may include the processing system executing specific functions of the second kernel 812.

In block 916, the processing system may retrieve the product Āxₜ from fast, short-term memory. In some embodiments retrieving the product Āxₜ from fast, short-term memory may include the processing system executing specific functions of the second kernel 812.

In block 918, the processing system may add the product \grave{B}uₜ and the product Āxₜ. This addition of products may generate a new state value (new state value 830; xₜ₊₁) for a current time t+1. In some embodiments, add the product \acute{B}uₜ and the product Āxₜ may include the processing system executing specific functions of the second kernel 812.

In block 920, the processing system may store the new state value in memory 804. In some embodiments, storing the new state value may include overwriting an old state value in the memory 806. The old state value that may be overwritten may be the old state value used in generating the new state value. In some embodiments, storing the new state value to the memory 804 may include the processing system executing specific functions of the second kernel 812.

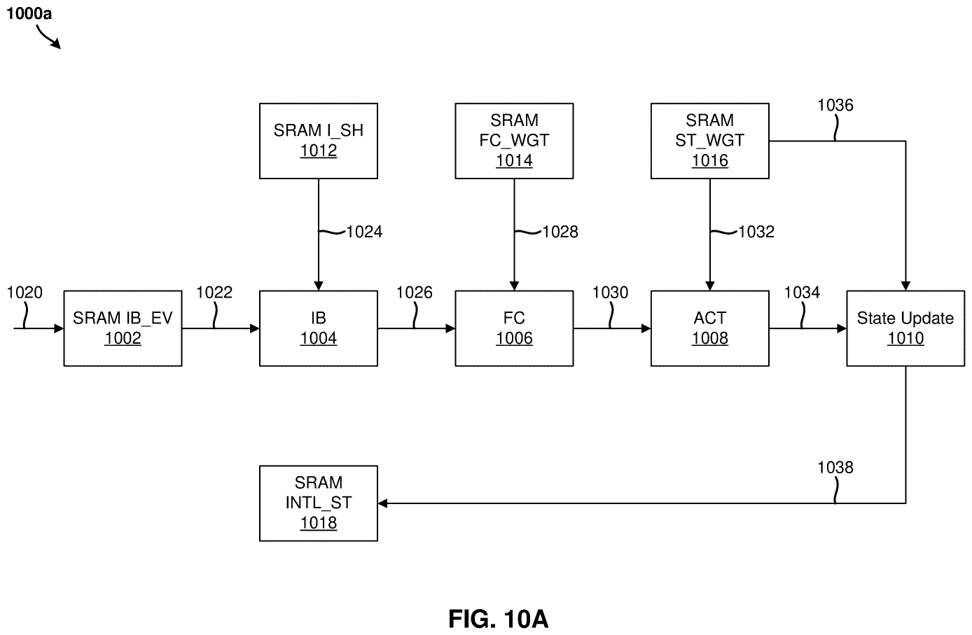

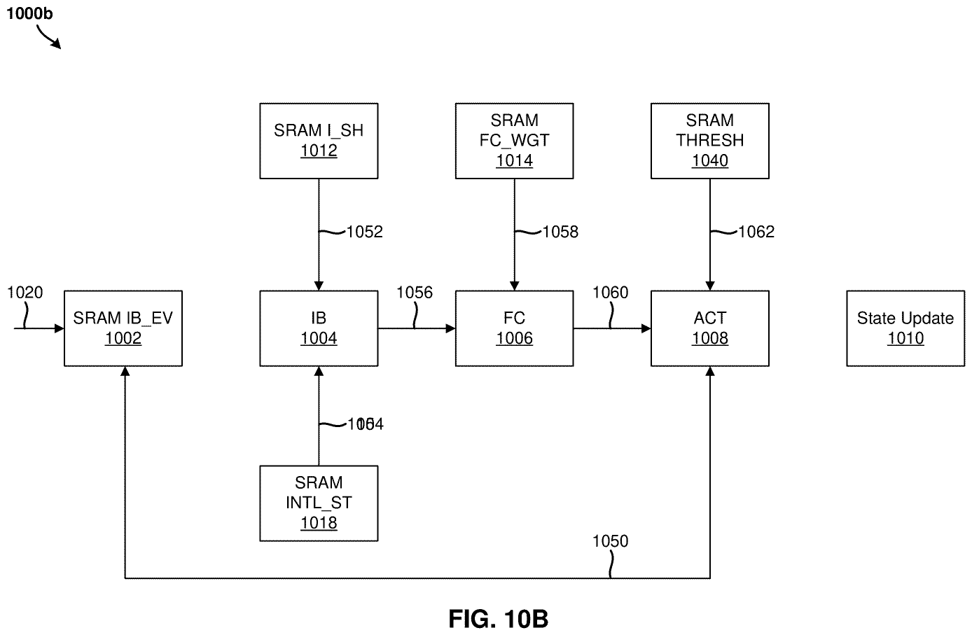

FIGS. 10A and 10B illustrate examples of fixed-point quantization of internal states in accordance with some embodiments. Quantization of recurrent layers can be difficult, as there is no clear way to control the accumulation of round-off errors via state updates. In some embodiments, dyadic fixed-point quantization involving shifts to control the scales of the elements may overcome these difficulties. In dyadic fixed-point quantization, dyadic numbers expressed as rational numbers of an integer k divided by 2ⁿ, where n is a non-negative integer, may be quantized to a designated number of bits such that a dyadic fixed-point number x=k·2⁻ⁿ, where k is a quantized integer and 2⁻ⁿ is a scaling factor.

The dyadic fixed-point quantization may include quantizing both the A matrix and the state x of the SSM 302, 306, 502 to 16-bit instead of 8-bit for the balance between reducing state update precision errors and saving computational logic area. All elements in the state x may share a same quantizer, which may reduce round-off errors caused by shift operation. The dyadic quantization scheme may be executed in the two loops: 1) input projection fused with state update 1000a illustrated in 10A, and 2) output projection 1000b illustrated in FIG. 10B.

Input projection fused with state update 1000a may include receiving a data input 1020 (e.g., input 210, 510, 512, 828) at a memory 1002 (e.g., SRAM) input buffer for event-based processing (SRAM IB_EV). Processing of the data input 1020 at the memory 1002 may be implemented in response to the satisfaction of the event criterion. For example, an event criteria for the event-based processing of the data input 1020 at the memory 1002 may include a non-zero value of the data input 1020. Satisfaction of the event criteria may trigger processing of the data input 1020 at the memory 1002.

In response to the satisfaction of the event criteria, values of the data input 1022 may be written from the memory 1002 to an input buffer 1004 (IB). The size of the input buffer 1004 may limit the amount of values of the data input 1022 that may be written for each event satisfying the event criteria or the number of events that may trigger processing until the input buffer 1004 is filled. For example, the input buffer 1004 may be 32 bits and each value of the data input 1022 may be 8 bits. Based on these parameters four value of the data input 1022 per event or one value of the data input 1022 for four events may be written to the input buffer 1004.

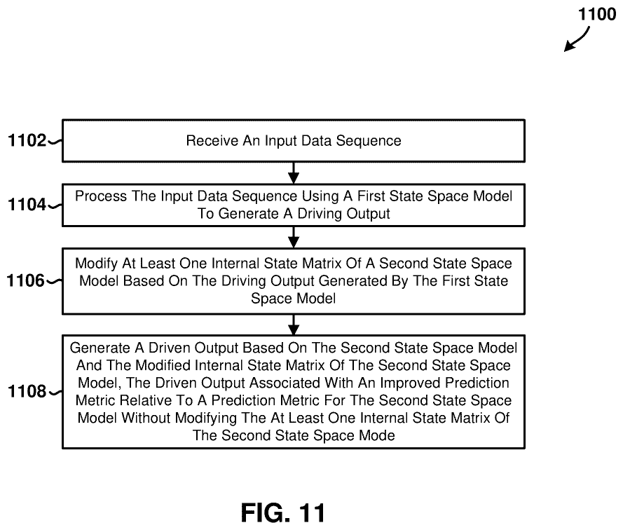

FIG. 11 illustrates an example flow/method 1100 for implementing fixed-point quantization of internal states in accordance with some embodiments. Method 1100 may be performed in a computing device by a processing system encompassing one or more processors (e.g., processors 120-132, etc.), components, or subsystems discussed in this application. The processing system may execute processing system-executable instructions (e.g., modules 202-208) stored on a non-transitory processor-readable medium (e.g., memory 136).

In block 1102, the processing system may receive an input data sequence. In block 1104, the processing system may process the input data sequence using a first SSM. In some embodiments, the first SSM may correspond to a driving SSM layer of a feedforward neural network architecture. In some embodiments, the processing system may generate a first driving output of the driving SSM layer based on the input data sequence. In some embodiments, the processing system may generate a feedforward output signal of the driving SSM layer. In some embodiments, the processing system may convey the feedforward output signal to a second SSM via a feedforward connection. In some embodiments, the processing system may perform the operations in block 1104 via an associative scan algorithm or a cumulative sum operation.

In some embodiments, in block 1104, the processing system may process the input data sequence using a second driving SSM layer. The processing system may generate a second driving output of the second driving SSM layer based on the input data sequence.

In some embodiments, in block 1104, the processing system may combine the first driving output and the second driving output. The processing system may generate a combined driving output based on the combination.

In some embodiments, the processing system may apply an activation function to the first driving output or the combined driving output. The processing system may generate a modified driving output based on an output of the activation function. In some embodiments, the activation function may include a nonlinear activation function with an output range from −1 to +1. The output range may improve the stability of the second SSM. In some embodiments, the nonlinear activation function may include a tanh activation function.

In block 1106, the processing system may modify at least one internal state matrix of a second SSM based on the first driving output, the combined driving output, or the modified driving output. In some embodiments, the second SSM may correspond to a driven SSM layer of the feedforward neural network architecture. In some embodiments, the processing system may convey the first driving output, the combined driving output, or the modified driving output to the driven SSM layer via a lateral connection. The processing system may modify the at least one internal state matrix via parameterization. Parameterization may adjust one or more values of the at least one internal state matrix based on the first driving output, the combined driving output, or the modified driving output. The at least one internal state matrix may include a diagonal state transition matrix (Ā) of the driven SSM layer. At least one internal state matrix may include an input matrix B′ of the driven SSM layer. At least one internal state matrix may include an output matrix C of the driven SSM layer. Prior to modifying B′ or C, the processing system may generate a low-rank projection of B′ or C. The low rank projection may reduce the dimensionality of B′ or C prior to parameterization. The first driving output, the combined driving output, or the modified driving output may influence the operation of the driven SSM layer via the parameterized at least one internal state matrix.

In some embodiments, the processing system may identify a second driven SSM layer different from the driven SSM layer. The processing system may modify at least one internal state matrix of the second driven SSM layer based on the first driving output, the combined driving output, or the modified driving output.

In block 1108, the processing system may generate a driven output based on the driven SSM layer and the modified at least one internal state matrix. In some embodiments, the processing system may process the driven SSM layer based on a model input that includes the input data sequence or the feedforward output signal. In some embodiments, the processing system may perform block 1108 via an associative scan algorithm or a cumulative sum operation. In some embodiments, the processing system may generate a first driven output via the driven SSM layer and may generate a second driven output via the second driven SSM layer. In some embodiments, the processing system may generate the driven output based on a combination of the first driven output and the second driven output. The driven output may correspond to an improved prediction metric relative to a prediction metric for the driven SSM layer without modification of the at least one internal state matrix of the driven SSM layer. The improved prediction metric may have a greater likelihood to account for a dependency related to a history or context associated with the input data sequence.

Some embodiments may include methods performed by a processing system of a computing device for generating a driven output from an input data sequence using interconnected SSMs. In some embodiments, the methods may include receiving the input data sequence, executing, during inference, a first SSM by updating a first state vector using a first state-space coefficient set and an input vector derived from the input data sequence and by generating a driving output using the first state-space coefficient set, deriving, using the driving output, a matrix control vector, parameterizing, during the inference and using the matrix control vector, at least one state-space coefficient set stored in a memory and used by a second SSM to update a second state vector and to generate a driven output, executing, during the inference, the second SSM by updating the second state vector using the at least one state-space coefficient set as parameterized and an input vector derived from the input data sequence and by generating the driven output using the at least one state-space coefficient set as parameterized, and outputting the driven output.

Some embodiments may further include applying a lateral activation function to the driving output to generate a modified driving output and deriving the matrix control vector using the modified driving output. Some embodiments may further include applying the lateral activation function as a bounded, nonlinear function that produces the modified driving output within the range −1 to +1. Some embodiments may further include applying the bounded nonlinear function as a hyperbolic tangent function. Some embodiments may further include representing the at least one state-space coefficient set with a state transition matrix, an input matrix, and an output matrix. Some embodiments may further include parameterizing the state transition matrix using the matrix control vector (e.g., by writing time-varying element values into the state transition matrix). Some embodiments may further include constraining the time-varying element values by clipping them to a magnitude bound stored in memory.

Some embodiments may further include configuring the state transition matrix as a diagonal matrix and mapping the matrix control vector to diagonal element values of the diagonal matrix. Some embodiments may further include using the matrix control vector to parameterize the input matrix by generating and storing low-rank factors, and generating a projected input vector by applying the input matrix parameterized by the low-rank factors to an input vector derived from the input data sequence. Some embodiments may further include parameterizing the output matrix by generating low-rank factors, storing the low-rank factors, and generating the driven output by applying the output matrix parameterized by the low-rank factors to the second state vector.

Some embodiments may further include generating a second driving output by executing, during the inference, a third SSM, combining the driving output and the second driving output to generate a combined driving output, and deriving the matrix control vector using the combined driving output. Some embodiments may further include selecting a parameterization granularity and assigning a respective matrix control vector to each time index of the input data sequence. Some embodiments may further include selecting a parameterization granularity, assigning a respective matrix control vector to each data segment of the input data sequence, and reusing the respective matrix control vector across multiple time indices of the data segment. Some embodiments may further include forming the at least one state-space coefficient set as parameterized by combining an input-independent base coefficient set and an input-dependent coefficient set derived from the matrix control vector. Some embodiments may further include applying an additive modulation to the input-independent base coefficient set using a gain coefficient stored in the memory. Some embodiments may further include applying a multiplicative modulation to the input-independent base coefficient set using a gain coefficient stored in the memory.

Some embodiments may include methods performed by a processing system of a computing device for processing an input data sequence using interconnected SSMs. In some embodiment, the methods may include receiving the input data sequence, executing, during inference, a first SSM stored in a memory by updating a first state vector using a first state transition matrix and a first input matrix and generating a driving output using a first output matrix, deriving a matrix control vector as a function of the driving output, parameterizing, during the inference and based on the matrix control vector, at least one internal state matrix of a second SSM stored in the memory, executing, during the inference, the second SSM using the at least one internal state matrix as parameterized by updating a second state vector using a second state transition matrix and a second input matrix and generating a driven output using a second output matrix and the second state vector, and outputting the driven output.

Some embodiments may further include applying a lateral activation function to the driving output to generate a modified driving output and deriving the matrix control vector as a function of the modified driving output. Some embodiments may further include applying the lateral activation function as a bounded nonlinear function producing the modified driving output within a closed interval bounded by −1 and +1. Some embodiments may further include applying the bounded nonlinear function as a hyperbolic tangent function. Some embodiments may further include parameterizing the at least one internal state matrix by writing updated element values into the second state transition matrix. Some embodiments may further include configuring the second state transition matrix as a diagonal matrix.

Some embodiments may further include mapping the matrix control vector to diagonal element values of the second state transition matrix and storing the diagonal element values in the memory before updating the second state vector for a time index of the input data sequence. Some embodiments may further include parameterizing the at least one internal state matrix by writing updated element values into the second input matrix. Some embodiments may further include generating a low-rank representation of the second input matrix and writing updated low-rank factors into the low-rank representation based on the matrix control vector. Some embodiments may further include parameterizing the at least one internal state matrix by writing updated element values into the second output matrix.

Some embodiments may further include generating a low-rank representation of the second output matrix and writing updated low-rank factors into the low-rank representation based on the matrix control vector. Some embodiments may further include parameterizing the second SSM by updating a feedforward activation function applied to the driven output based on the matrix control vector. Some embodiments may further include organizing a plurality of SSMs including the first SSM and the second SSM into a control path and a feature path, executing the control path to generate the driving output, and executing the feature path to generate the driven output. Some embodiments may further include conveying the driving output from the control path to the feature path as the matrix control vector over a lateral connection defined in a network topology stored in the memory. Some embodiments may further include generating a feedforward output by applying a feedforward activation function to the driving output and providing the feedforward output as an input to the second SSM through a feedforward connection. Some embodiments may further include receiving the input data sequence as an input to the first SSM and as an input to the second SSM. Some embodiments may further include executing, during the inference, a third SSM to generate a second driving output, combining the driving output and the second driving output to generate a combined driving output, and deriving the matrix control vector as a function of the combined driving output.

Some embodiments may further include applying the lateral activation function to the driving output to generate a first modified driving output, applying the lateral activation function to the second driving output to generate a second modified driving output, and combining the first modified driving output and the second modified driving output to generate the combined driving output. Some embodiments may further include selecting a parameterization granularity assigning a respective matrix control vector to each time index of the input data sequence. Some embodiments may further include selecting a parameterization granularity assigning a respective matrix control vector to each data segment of the input data sequence and reusing the respective matrix control vector across multiple time indices within the data segment.

Some embodiments may further include forming the at least one internal state matrix as a sum of an input-independent base matrix and a gain-scaled input-dependent matrix derived from the matrix control vector. Some embodiments may further include forming the at least one internal state matrix as a product of an input-independent base matrix and an input-dependent matrix derived from the matrix control vector. Some embodiments may further include constraining element values written into the second state transition matrix by clipping the element values to a magnitude bound stored in the memory. Some embodiments may further include initializing a gain coefficient applied to the gain-scaled input-dependent matrix to zero during training and updating the gain coefficient toward a nonzero value during the training based on gradients of a training loss. Some embodiments may further include executing the first SSM using an associative scan algorithm that combines recurrent-update operands to compute first state-vector updates in parallel and executing the second SSM using the associative scan algorithm to compute second state-vector updates in parallel.

Some embodiments may further include executing the second SSM using a cumulative sum operation that computes a cumulative product of diagonal elements of the second state transition matrix and a cumulative sum of scaled projected inputs. Some embodiments may further include executing the cumulative sum operation in a logarithmic domain using a logsumexp operation. Some embodiments may further include generating a positive component of an input signal and a negative component of the input signal, executing the cumulative sum operation separately for the positive component and the negative component, and combining results of the cumulative sum operation by subtraction to generate the second state vector. Some embodiments may further include storing intermediate state-update values in an on-chip memory across an input projection operation and a state update operation and avoiding storing the intermediate state-update values in an off-chip memory.

Some embodiments may further include executing the first SSM for a current time index while executing the second SSM for a previous time index using a previous instance of the at least one internal state matrix as parameterized. Some embodiments may further include identifying input elements of an input vector having values failing an event criterion and skipping multiply-accumulate operations for the input elements failing the event criterion while updating the second state vector. Some embodiments may further include quantizing the second state vector and the at least one internal state matrix using a dyadic fixed-point representation and replacing a scaling multiplication associated with the dyadic fixed-point representation with a shift operation while executing the second SSM. Some embodiments may further include allocating a first parameter buffer and a second parameter buffer in the memory and alternating writes of the at least one internal state matrix as parameterized between the first parameter buffer and the second parameter buffer across successive time indices.

Some embodiments may further include accumulating a plurality of feedforward outputs generated by a first level of an interconnected SSM network to generate an accumulated feature input, and providing the accumulated feature input to a second level of the interconnected SSM network. Some embodiments may further include dispatching a fused state-update kernel to a neural processing unit of a system-on-chip and dispatching a control-vector derivation kernel to a digital signal processor of the system-on-chip. Some embodiments may further include receiving the input data sequence as an audio signal and generating the driven output as an enhanced audio signal. Some embodiments may further include receiving the input data sequence as token embeddings representing text and generating the driven output as logits for next-token prediction. Some embodiments may further include receiving the input data sequence as a medical time-series signal and generating the driven output as a medical inference output derived from the medical time-series signal.

Some embodiments may include methods performed by a processing system of a computing device for updating a state vector of a SSM using event-based processing and fused input projection. In some embodiments, the methods may include receiving an input vector for a time index, identifying a subset of input elements of the input vector satisfying an event criterion, loading an old state tile of an old state vector of the SSM and a matrix tile of a state transition matrix of the SSM into an on-chip memory, computing a recurrent tile product by multiplying the old state tile and the matrix tile, accumulating an input-projection tile in the on-chip memory by multiplying the subset of input elements and corresponding portions of an input matrix of the SSM without writing an intermediate full input-projection vector to an off-chip memory, adding the recurrent tile product and the input-projection tile to generate a new state tile, and storing the new state tile into a state memory as a portion of a new state vector of the SSM. Some embodiments may further include configuring the state transition matrix as a diagonal matrix and updating state elements of the old state vector independently for the time index. Some embodiments may further include overwriting the old state vector with the new state vector in the state memory. Some embodiments may further include generating the input vector by applying a rectified linear unit activation function to an output of a preceding neural network layer. Some embodiments may further include storing the recurrent tile product in a register file of a processing core and adding the recurrent tile product and the input-projection tile using a single kernel invocation.

Some embodiments may include methods performed by a processing system of a computing device for executing a SSM using dyadic fixed-point quantization. In some embodiments, the methods may include receiving an input vector, representing a state vector of the SSM in a dyadic fixed-point representation, representing a state transition matrix of the SSM in the dyadic fixed-point representation, updating the state vector by computing an integer-domain product between the state transition matrix and the state vector and applying a shift operation for dyadic scaling, accumulating an integer-domain input projection using an input matrix of the SSM and the input vector, adding the integer-domain product and the integer-domain input projection to generate an updated state vector, and outputting an output vector computed from the updated state vector using an output matrix of the SSM. Some embodiments may further include sharing a single quantizer exponent across all elements of the state vector while representing the state vector in the dyadic fixed-point representation. Some embodiments may further include selecting a first bit width for the state vector and the state transition matrix that is greater than a second bit width for the input vector.

Some embodiments may include methods performed by a processing system of a computing device for parallelizing the execution of a time-varying SSM. In some embodiments, the methods may include receiving an input data sequence, generating, for each time index of the input data sequence, a respective recurrent matrix and a respective projected input vector, combining the respective recurrent matrices and the respective projected input vectors using an associative scan operation producing scanned recurrent matrices and scanned projected input vectors, computing, from the scanned recurrent matrices and the scanned projected input vectors, a sequence of state vectors, and generating an output data sequence by projecting the sequence of state vectors using an output matrix. Some embodiments may further include combining a first pair including a first recurrent matrix and a first projected input vector and a second pair including a second recurrent matrix and a second projected input vector by multiplying the second recurrent matrix and the first recurrent matrix to produce a combined recurrent matrix and adding a product of the second recurrent matrix and the first projected input vector to the second projected input vector to produce a combined projected input vector. Some embodiments may further include executing the time-varying SSM for a diagonal recurrent matrix by computing a cumulative product of diagonal elements and computing a cumulative sum of scaled projected input values using a logsumexp operation.

Some embodiments may include methods performed by a processing system of a computing device for executing an interconnected SSM network having a control path and a feature path. In some embodiments, the methods may include storing, in a memory, a network topology defining a control path including a plurality of control-path SSMs and defining a feature path including a plurality of feature-path SSMs and defining a respective lateral connection from at least one of the control-path SSMs to each feature-path SSM, receiving an input data sequence including a plurality of time-indexed input vectors, executing, during inference and for each time-indexed input vector, the control path by updating a respective control-path state vector for each control-path SSM and generating a respective control-path driving output for each control-path SSM, generating, for each feature-path SSM, a respective matrix control vector using at least one control-path driving output conveyed over the respective lateral connection, parameterizing, during the inference and for each time-indexed input vector, at least one internal state matrix of each feature-path SSM using the respective matrix control vector, executing, during the inference and for each time-indexed input vector, the feature path by updating a respective feature-path state vector for each feature-path SSM using the at least one internal state matrix as parameterized and generating a feature output sequence from the feature path, outputting an output derived from the feature output sequence.

Some embodiments may further include applying a lateral activation function to each control-path driving output to generate a respective modified control-path driving output, generating each respective matrix control vector using at least one respective modified control-path driving output. Some embodiments may further include combining a plurality of control-path driving outputs conveyed over the respective lateral connection to generate the respective matrix control vector. Some embodiments may further include selecting a segment length defining a data segment of the input data sequence, generating the respective matrix control vector for each feature-path SSM once per data segment, and reusing the respective matrix control vector across a plurality of time-indexed input vectors of the data segment. Some embodiments may further include allocating a first parameter buffer and a second parameter buffer in the memory, alternating writes of the at least one internal state matrix as parameterized between the first parameter buffer and the second parameter buffer across successive time-indexed input vectors, executing the control path for a current time-indexed input vector while executing the feature path for a previous time-indexed input vector using the at least one internal state matrix stored in one of the first parameter buffer and the second parameter buffer.

Some embodiments may further include identifying, for an input vector provided to a feature-path SSM, a subset of input elements satisfying an event criterion, skipping multiply-accumulate operations for input elements failing the event criterion, and updating the respective feature-path state vector using the subset of input elements satisfying the event criterion.

Some embodiments may further include computing a recurrent tile product by multiplying a tile of an old feature-path state vector and a tile of a feature-path state transition matrix, accumulating an input-projection tile in an on-chip memory by multiplying input elements of an input vector and corresponding portions of a feature-path input matrix, adding the recurrent tile product and the input-projection tile to generate a tile of an updated feature-path state vector, writing the tile of the updated feature-path state vector to a state memory, avoiding writing an intermediate full input-projection vector to an off-chip memory.

Some embodiments may further include quantizing the respective feature-path state vector using a dyadic fixed-point representation, quantizing at least one internal state matrix using the dyadic fixed-point representation, and replacing a scaling multiplication for dyadic scaling with a shift operation during updating the respective feature-path state vector.

Some embodiments may further include generating, for each time-indexed input vector, a respective recurrent matrix and a respective projected input vector for a feature-path SSM, combining the respective recurrent matrices and the respective projected input vectors using an associative scan operation, and generating the respective feature-path state vector using a result of the associative scan operation. Some embodiments may further include configuring the at least one internal state matrix as a diagonal state transition matrix, computing a cumulative product of diagonal elements of the diagonal state transition matrix, computing a cumulative sum of scaled projected input values using the cumulative product, and generating the respective feature-path state vector using the cumulative sum.

Some embodiments may further include executing the cumulative sum in a logarithmic domain using a logsumexp operation. Some embodiments may further include storing intermediate state-update values for a feature-path SSM in on-chip memory during an input projection operation and a state update operation, thereby avoiding storing them in off-chip memory. Some embodiments may further include receiving the input data sequence as an audio signal and outputting the enhanced audio signal. Some embodiments may further include receiving the input data sequence as token embeddings representing text and outputting the output as logits for next-token prediction.

Some embodiments include a computing device that pairs a driving SSM layer with a driven SSM layer. The driving SSM layer may process an input data sequence and generate a driving output that reflects the context within the input data sequence. The driven SSM layer may use the driving output to parameterize at least one state transition matrix during inference for the input data sequence. The driven SSM layer may generate a driven output that adapts to shifts in the input data sequence without a separate retraining step. Event-based processing and on-chip state update operations decrease computation and decrease DRAM read traffic for the input data sequence.

The embodiments include a lateral connection that carries a driving output from a driving SSM layer to a driven SSM layer for parameterization of a state transition matrix, an input matrix, or an output matrix during inference. Unlike SSM networks that propagate features through feedforward connections and hold matrix values fixed during inference, the lateral connection may couple a recurrent control signal from the driving SSM layer with the state update of the driven SSM layer. Some embodiments may pair that control topology with event-based processing, kernel fusion for state updates, and dyadic fixed-point quantization for state updates. The embodiments may provide a coordinated control pathway and hardware-facing operations that target DRAM read traffic and per-frame latency within one execution path.

The embodiments may improve the performance and functionality of a computing system or network by parameterizing a driven SSM layer based on a driving output from a driving SSM layer. The processing system may parameterize a state transition matrix during inference, and the parameterization may align state updates with local context in an input data sequence. That alignment may improve a prediction metric for nonstationary sequences at a fixed model size. Event-based processing skips multiply-accumulate operations for zero input elements, and kernel fusion retains intermediate products in SRAM across an input projection and a state update. Dyadic fixed-point quantization replaces scaling multiplications with shift operations, and the replacement decreases arithmetic cost per state update. A decrease in DRAM read traffic and a decrease in per-frame latency raise throughput for concurrent sessions and decrease energy draw per session.

A processing system may encounter elevated DRAM read traffic and per-frame latency during inference for an input data sequence. The processing system may execute a driving SSM layer that generates a driving output for the input data sequence. The processing system may parameterize a state transition matrix of a driven SSM layer via a lateral connection based on the driving output. The processing system may execute event-based processing and kernel fusion for a state update and apply dyadic fixed-point quantization. Memory-controller read-byte counters may report, for example, a 30% to 70% decrease in DRAM read traffic during a 1 s audio benchmark at 16 kHz. Cycle counters may report, for example, a 5% to 25% decrease in per-frame latency for a 20 ms frame. Event-based processing, kernel fusion, and dyadic fixed-point quantization may decrease SRAM-to-DRAM transfers and decrease DRAM read traffic and energy.

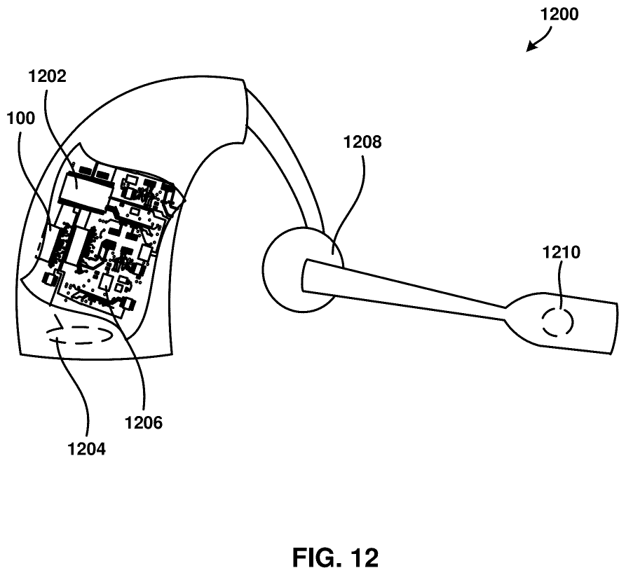

FIG. 12 is a component block diagram of an edge device 1200 suitable for use with various embodiments. With reference to FIGS. 1-12, various embodiments may be implemented on a variety of edge devices, an example of which is illustrated in FIG. 12 as a wearable computing device in the form of a headset 1200. A headset 1200 may include a SOC 100 coupled to memory 1202 (e.g., DDR4/DDR5 SDRAM, etc.), an antenna 1204, a wireless transceiver 1206, a speaker 1208, and a microphone 1210, any or all of which may be coupled to each other and/or to one or more processors 120-132 in the SOC 100. The memory 1202 may include standard-performance memory, high-performance memory, volatile memory, non-volatile memory, dynamic memory, static memory, or any combination thereof (e.g., static memory and standard-performance volatile memory, etc.).

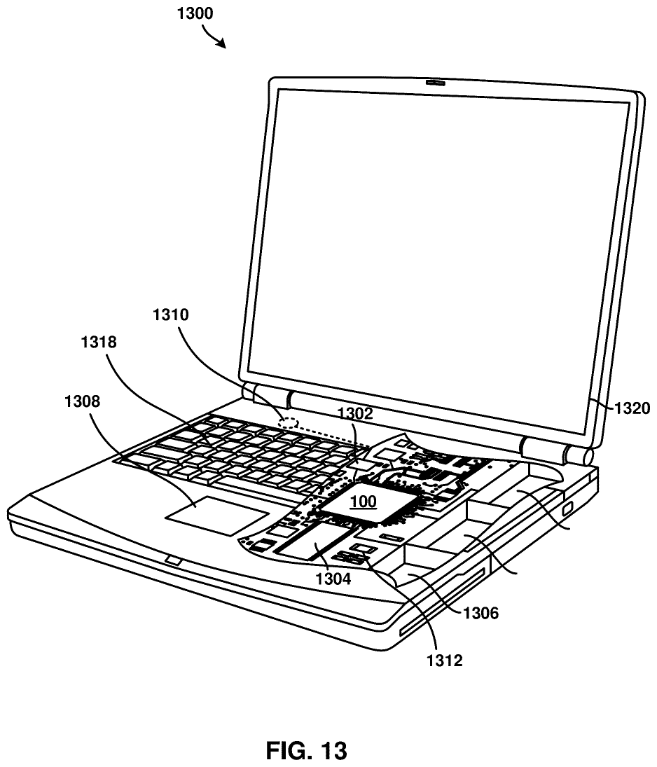

FIG. 13 is a component block diagram of an edge device 1300 suitable for use with various embodiments. With reference to FIGS. 1-13, various embodiments may be implemented on a variety of edge devices, an example of which is illustrated in FIG. 13 in the form of a laptop computer 1300. A laptop 1300 may include a SoC 100 and/or a processor 1302 coupled to a memory 1304, which may include standard-performance memory, high-performance memory, volatile memory, non-volatile memory, dynamic memory, static memory, or any combination thereof. For example, memory 1304 may include dynamic random-access memory (DRAM) for volatile storage and non-volatile memory such as flash or solid-state storage, such as a Non-Volatile Memory Express (NVMe) solid-state drive (SSD) 1306. The laptop 1300 may include multiple antennas 1310 designed to support various wireless communication standards, including Wi-Fi 6/6E, 5G cellular connectivity, and Bluetooth. These antennas are connected to a wireless data link and a cellular transceiver 1312, both of which are coupled to the processor 1302. In addition, the laptop 1300 may include a precision touchpad 1308 that supports multi-touch gestures and other modern input/output peripherals, such as a backlit keyboard 1318 and a high-resolution display 1320 (e.g., 4K OLED or Mini-LED). The laptop 1300 may also include biometric sensors for authentication, such as a fingerprint reader or facial recognition, all of which are integrated and controlled by the processor 1302.

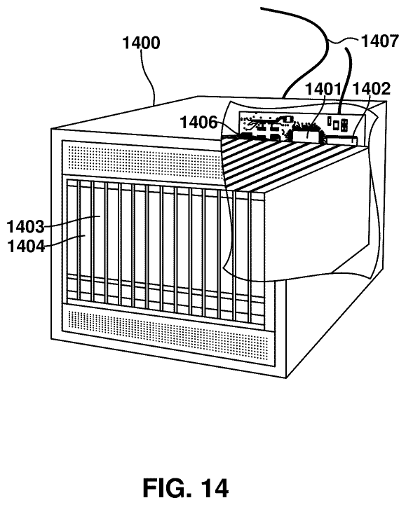

All or portions of some embodiments may be implemented in the cloud or on a variety of commercially available computing devices, such as the server computing device 1400 illustrated in FIG. 14. The server device 1400 may include one or more processors 1401 (e.g., multi-core processor, etc.) coupled to volatile memory 1402, such as RAM, and a large capacity nonvolatile memory, such as a solid-state drive (SSD) 1403. The server device 1400 may also include additional storage interfaces such as USB ports and NVMe slots coupled to the processor 1401. The server device 1400 may include network access ports 1406 coupled to the processor 1401 that allow data connections through a network interface card (NIC) 1404 and a communication network 1407 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Servers often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

Implementation examples are described in the following paragraphs. While some of the following implementation examples are described in terms of example methods, further example implementations may include: the example methods discussed in the following paragraphs implemented by a computing system including a processor configured (e.g., with processor-executable instructions) to perform operations of the methods of the following implementation examples, the example methods discussed in the following paragraphs implemented by a computing system including means for performing functions of the methods of the following implementation examples, the example methods discussed in the following paragraphs may be implemented as a non-transitory processor-readable storage medium having stored thereon processor-executable instructions configured to cause a processor of a computing system to perform the operations of the methods of the following implementation examples, and the example methods discussed in the following paragraphs may be implemented as a non-transitory processor-readable storage medium having stored thereon data and configurations to control a state machine or cause a processor to perform the operations of the methods of the following implementation examples.

In Example 1, a method of implementing a plurality of SSMs (SSM) by a processing system includes receiving a first data input at a first driving SSM, generating a first driving output of the first driving SSM based on the data input, parameterizing a first driven SSM based on the first driving output, wherein the first driving SSM and the first driven SSM are connected by a lateral connection, receiving a second data input at the first driven SSM, and generating a first driven output of the first driven SSM based on parameterization of the first driven SSM and the second data input.

In Example 2, the method of Example 1 may include parameterizing the first driven SSM based on the first driving output including parameterizing weights of a matrix of the first driven SSM based on the first driving output.

In Example 3, the method of any of Examples 1-2 may include executing an activation function based on the first driving output generating an activation output, wherein parameterizing the first driven SSM based on the first driving output includes parameterizing the first driven SSM based on the activation output.

In Example 4, the method of any of Examples 1-3 may include receiving the first data input at a second driving SSM, generating a second driving output of the second driving SSM based on the data input, and combining the first driving output and the second driving output generating a combined output, wherein parameterizing the first driven SSM based on the driving output includes parameterizing the first driven SSM based on the combined output, wherein the second driving SSM and the first driven SSM are connected by a lateral connection.

In Example 5, the method of Example 4 may include executing an activation function based on the combined output generating an activation output, wherein parameterizing the first driven SSM based on the combined output includes parameterizing the first driven SSM based on the activation output.

In Example 6, the method of any of Examples 1-5 may include receiving the first data input at a second driving SSM, generating a second driving output of the second driving SSM based on the data input, executing a first activation function based on the first driving output generating a first activation output, executing a second activation function based on the second driving output generating a second activation output, and combining the first activation output and the second activation output generating a combined output, wherein parameterizing the first driven SSM based on the driving output includes parameterizing the first driven SSM based on the combined output, wherein the second driving SSM and the first driven SSM are connected by a lateral connection.

In Example 7, the method of any of Examples 1-6 may include parameterizing a second driven SSM based on the first driving output, wherein the first driving SSM and the second driven SSM are connected by a lateral connection, receiving a third data input at the first driven SSM, and generating a second driven output of the second driven SSM based on parameterization of the second driven SSM and the third data input.

In Example 8, the method of Example 7 may include executing an activation function based on the first driving output generating an activation output, wherein parameterizing the first driven SSM based on the first driving output includes parameterizing the first driven SSM based on the activation output, and parameterizing the second driven SSM based on the second driving output includes parameterizing the second driven SSM based on the activation output.

In Example 9, the method of any of Examples 1-8 may include the first driving SSM and the first driven SSM being connected by a feedforward connection.

In Example 10, the method of any of Examples 1-9 may include the second data input being the first data input.

In Example 11, the method of any of Examples 1-10 may include the first driving SSM and the first driven SSM being on a same level of an interconnected SSM network.

In Example 12, the method of any of Examples 1-11 may include the first driving SSM and the first driven SSM being on different levels of an interconnected SSM network.

In Example 13, a method of event-based processing and kernel fusion by a processing system includes multiplying an old state value of an SSM for a prior time and state matrix value by a first kernel to generate a first kernel output, multiplying a data input value for the prior time and a control matrix value by a second kernel to generate a second kernel output, and adding the first kernel output and the second kernel output by the second kernel to generate an updated state value for a time.

In Example 14, the method of Example 13 may include storing the updated state value to a memory.

In Example 15, the method of Example 14 may include storing the updated state value to the memory including overwriting the old state value in the memory.

In Example 16, the method of any of Examples 13-15 may include storing the first kernel output in a short-term memory.

In Example 17, a computing device includes a processing system that includes at least one processor configured with processor-executable instructions to perform any of the operations recited in any of Examples 1-16.

In Example 18, a computing device includes means for performing functions of any of the operations recited in any of Examples 1-16.

In Example 19, a non-transitory processor-readable storage medium has stored thereon processor-executable instructions to cause at least one processor in a processing system in a computing device to perform any of the operations recited in any of Examples 1-16.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

1. A computing device, comprising:
a memory storing instructions and a plurality of state space models;
a processor configured to execute the instructions to:
receive an input data sequence;
process the input data sequence using a first state space model to generate a driving output;
modify at least one internal state matrix of a second state space model based on the driving output generated by the first state space model; and
generate a driven output based on the second state space model and the modified internal state matrix of the second state space model, the driven output associated with an improved prediction metric relative to a prediction metric for the second state space model without modifying the at least one internal state matrix of the second state space model.

2. The computing device of claim 1, wherein the processor is further configured to execute the instructions to:
apply an activation function to the driving output signal to generate a modified driving output, the modified driving output being used to modify the internal state matrix of the second state space model.

3. The computing device of claim 2, wherein the activation function is a non-linear activation function bounded by values −1 and +1, the bound improving a likelihood of stability of the second state space model.

4. The computing device of claim 3, wherein the activation function is a tanh activation function.

5. The computing device of claim 1, wherein the internal state matrix of the second state space model that is modified by the processor is a diagonal state transition matrix (Á) that is configured to govern the dynamics of the second state space model.

6. The computing device of claim 1, wherein the internal state matrix of the second state space model that is modified by the processor is at least one of an input matrix (\grave{B}) of the second state space model, or an output matrix (C) of the second state space model.

7. The computing device of claim 6, wherein the processor is further configured to execute the instructions to:
generate a low rank projection of the at least one of an input matrix (\grave{B}) of the second state space model, or the output matrix (C) of the second state space model prior to being modified based on the driving output generated by the first state space model, the low rank projection configured to reduce a dimensionality of the at least one of an input matrix (\grave{B}) of the second state space model, or the output matrix (C) of the second state space model.

8. The computing device of claim 1, wherein the first state space model is a driving state space model layer and the second state space model is a driven state space model layer, the driving state space model layer and the driven state space model layer being part of a feedforward neural network architecture.

9. The computing device of claim 8, wherein the driving output is a first driving output, the first state space model is a first driving state space model layer, and the processor is further configured to execute the instructions to:
generate a second driving output using a third state space model that is a second driving state space model layer; and
modify the at least one internal state matrix of the second state space model that is the driven state space model layer based on a combination of the first driving output and the second driving output.

10. The computing device of claim 8, wherein the second state space model is a first driven state space model layer, and the processor is further configured to execute the instructions to:
identify a third state space model that is a second driven state space model layer different than the first driven state space model layer;
modify at least one internal state matrix of the second driven state space model layer based on the driving output generated by the driving state space model layer; and
generate the driven output based on the first driven state space model layer and the second driven state space model layer.

11. The computing device of claim 1, wherein the processor is further configured to execute the instructions to:
modify the at least one internal state matrix of the second state space model by parameterizing the at least one internal state matrix of the second state space model, wherein parameterizing includes adjusting one or more values of the at least one internal state matrix of the second state space model based on the driving output generated by the first state space model.

12. The computing device of claim 1, wherein the processor utilizes an associative scan algorithm or a cumulative sum operation to parallelize the processing of the first state space model and the second state space model.

13. The computing device of claim 1, wherein the first state space model and the second state space model are connected via a lateral connection, the lateral connection used to convey the driving output from the first state space model to the second state space model.

14. The computing device of claim 1, wherein the first state space model and the second state space model are connected via a feedforward connection, the feedforward connection used to convey a feedforward output signal from the first state space model to the second state space model.

15. The computing device of claim 1, wherein the driving output is used to influence or configure the operation of the second state space model.

16. The computing device of claim 1, wherein the improved prediction metric associated with the input data sequence has a greater likelihood to account for a dependency related to a history or context associated with the input data sequence.

17. A method performed by at least one processor in a processing system of an edge device, the method comprising:
receiving an input data sequence;
processing the input data sequence using a first state space model to generate a driving output;
modifying at least one internal state matrix of a second state space model based on the driving output generated by the first state space model; and
generating a driven output based on the second state space model and the modified internal state matrix of the second state space model, the driven output associated with an improved prediction metric relative to a prediction metric for the second state space model without modifying the at least one internal state matrix of the second state space model.

18. The method of claim 17, further comprising:
applying an activation function to the driving output to generate a modified driving output, the modified driving output being used to modify the internal state matrix of the second state space model.

19. The method of claim 18, wherein the activation function is a non-linear activation function bounded by values-1 and +1, the bound improving a likelihood of stability of the second state space model.

20. The method of claim 17, wherein the internal state matrix of the second state space model that is modified is a diagonal state transition matrix (Á) that is configured to govern the dynamics of the second state space model.

21. The method of claim 17, wherein the internal state matrix of the second state space model that is modified is at least one of an input matrix (\grave{B}) of the second state space model, or an output matrix (C) of the second state space model.

22. The method of claim 17, wherein the first state space model is a driving state space model layer and the second state space model is a driven state space model layer, the driving state space model layer and the driven state space model layer being part of a feedforward neural network architecture.

23. The method of claim 22, wherein the driving output is a first driving output, the first state space model is a first driving state space model layer, and the method further comprises:
generating a second driving output using a third state space model that is a second driving state space model layer; and
modifying the at least one internal state matrix of the second state space model that is the driven state space model layer based on a combination of the first driving output and the second driving output.

24. The method of claim 22, wherein the second state space model is a first driven state space model layer, and the method further comprises:
identifying a third state space model that is a second driven state space model layer different than the first driven state space model layer;
modifying at least one internal state matrix of the second driven state space model layer based on the driving output generated by the driving state space model layer; and
generating the driven output based on the first driven state space model layer and the second driven state space model layer.

25. The method of claim 17, further comprising:
modifying the at least one internal state matrix of the second state space model by parameterizing the at least one internal state matrix of the second state space model, wherein parameterizing includes adjusting one or more values of the at least one internal state matrix of the second state space model based on the driving output generated by the first state space model.

26. The method of claim 17, wherein the processor utilizes an associative scan algorithm or a cumulative sum operation to parallelize the processing of the first state space model and the second state space model.

27. The method of claim 17, wherein the first state space model and the second state space model are connected via a lateral connection, the lateral connection used to convey the driving output from the first state space model to the second state space model.

28. The method of claim 17, wherein the first state space model and the second state space model are connected via a feedforward connection, the feedforward connection used to convey a feedforward output signal from the first state space model to the second state space model.

29. The method of claim 17, wherein the driving output is used to influence or configure the operation of the second state space model.

30. The method of claim 17, wherein the improved prediction metric associated with the input data sequence has a greater likelihood to account for a dependency related to a history or context associated with the input data sequence.

31. The method of claim 17, further comprising:
modifying a feedforward activation function of the second state space model based on the driving output generated by the first state space model, wherein the feedforward activation function is applied to an output of the second state space model.

32. A non-transitory processor-readable storage medium having stored thereon processor-executable instructions configured to cause a processor to perform operations comprising:
receiving an input data sequence;
processing the input data sequence using a first state space model to generate a driving output;
modifying at least one internal state matrix or an activation function associated with a second state space model based on the driving output generated by the first state space model; and
generating a driven output based on the second state space model and the modified internal state matrix of the second state space model, the driven output associated with an improved prediction metric compared to a prediction based on not modifying the at least one internal state matrix of the second state space model.
